(19) United States
(12) Patent Application Publication
(10) Pub. No.: US 2015/0302483 A1
(43) Pub. Date: Oct. 22, 2015

(54) CUSTOMIZED LANDING PAGE SYSTEM AND METHOD

(71) Applicant: The Captiveyes Group Inc., Tallahassee, FL (US)

(72) Inventor: William R. Wilson, V, Tallahassee, FL (US)

(21) Appl. No.: 14/449,841

(22) Filed: Aug. 1, 2014

Related U.S. Application Data
(60) Provisional application No. 61/981,153, filed on Apr. 17, 2014.

(51) Int. Cl. G06Q 30/02; H04L 29/08; H04L 29/06; G06Q 50/00

(52) U.S. Cl. CPC G06Q 30/0269; G06Q 30/0203; G06Q 30/0218; G06Q 50/01; H04L 67/22; G06Q 30/0272; H04L 63/08; H04L 67/02

(57) ABSTRACT

Systems and methods are described herein that provide user(s) with a customized landing page that is based on a location (e.g., a business or organization) at which the user is located. The customized landing page may be configured to enable a consumer to access the Internet via an Internet hotspot provided by the business or organization. The customized landing page may require the consumer(s) to perform certain actions before enabling a consumer to access the Internet. Such actions include, but are not limited to, viewing advertisements, providing demographic information and/or contact information, and/or interacting with one or more services. Upon connecting to the Internet, various performance indicators associated with the consumer(s) may be determined An administrator of a hotspot provider may be enabled to view the performance indicator(s) and market themselves accordingly.

### CROSS REFERENCE TO RELATED APPLICATION

This application claims priority to U.S. Provisional Application Ser. No. 61/981,153, filed Apr. 17, 2014, and titled “Wi-Fi Hotspot Advertisement Creator,” the entirety of which is incorporated by reference herein.

### BACKGROUND OF THE INVENTION

1. Field of the Invention

The subject matter described herein relates to devices and networks that utilize wireless networks.

2. Background

A hotspot is a site that offers Internet access over a wireless network. Hotspots typically use Wi-Fi technology to provide access to the Internet. Hotspots may be found in restaurants, airports, libraries, hotels, coffee shops, bookstores, department stores, supermarkets, and various other public establishments. Establishments may provide hotspots to attract more customers, build customer loyalty, and offer a competitive advantage against other businesses.

### BRIEF SUMMARY OF THE INVENTION

Methods, systems, and apparatuses are described for providing users with a customized landing page based on the user's location and/or enabling a business or organization that provides Internet access via an Internet hotspot to obtain various performance indicator(s) associated with its consumers, substantially as shown in and/or described herein in connection with at least one of the figures, as set forth more completely in the claims.

In particular, a method for providing Internet access at a location is described herein. In accordance with the method, a request is received for a landing page. The request includes parameter(s). One of a first landing page or a second landing page are provided to a user device of a user based on the parameter(s). The second landing page enables the user to interact with service(s) that are associated with the location, and the first landing page does not enable the user to interact with the service(s). Upon providing the second landing page, a determination is made as to whether the user has interacted with the service(s), and access is provided to the Internet in response to a determination that the user has interacted with the service(s).

A system for providing Internet access at a location is also described herein. The system includes a request receiver, a landing page provider, an interaction detector, and an access grantor. The request receiver is configured to receive a request for a landing page, wherein the request includes parameter(s). The landing page provider is configured to provide one of a first landing page or a second landing page based on the parameter(s) to a user device of a user. The second landing page enables the user to interact with service(s) that are associated with the location, and the first landing page does not enable the user to interact with the service(s). The interaction detector is configured to determine whether the user has interacted with the service(s) upon provision of the second landing page. The access grantor is configured to provide access to the Internet in response to a determination that the user has interacted with the service(s).

Another method is also described herein. In accordance with the method, a request is received for a web page that provides performance indicator(s) for users that accessed the Internet via a network device located at a particular location. The performance indicator(s) for the users are retrieved, and the web page is provided.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of a communication system in which users are provided with a customized landing page that enables a user to connect to the Internet via a hotspot provided by a hotspot provider, according to an example embodiment.

FIG. 2 is a block diagram illustrating the operations performed by a system that enables a consumer device to connect to the Internet via a customized landing page, according to an example embodiment.

FIG. 3 is a block diagram illustrating the operations performed by a system to enable a consumer to interact with service(s), according to an example embodiment.

FIG. 4 shows a flowchart for providing conditional access to the Internet via a hotspot based on whether a user has interacted with service(s) via a landing page, according to an example embodiment.

FIG. 5 shows a block diagram of a system that provides conditional access to the Internet via a hotspot based on whether a user has interacted with service(s) via a landing page, according to an example embodiment.

FIG. 6 shows a flowchart for providing access to the Internet after the provision of advertisement(s), according to an example embodiment.

FIG. 7 shows a block diagram of a system that provides access to the Internet after the provision of advertisement(s), according to an example embodiment.

FIG. 8 shows a block diagram illustrating the operations performed by a system that determines metric(s) associated with advertisement(s), according to an example embodiment.

FIG. 9 shows a flowchart for determining metric(s) associated with advertisement(s), according to an example embodiment.

FIG. 10 shows a block diagram of a system that that determines metric(s) associated with advertisement(s), according to an example embodiment.

FIG. 11 shows a block diagram illustrating the operations performed by a system that determines demographic information associated with consumer(s), according to an example embodiment.

FIG. 12 shows a flowchart for providing a demographic information page or section, according to an example embodiment.

FIG. 13 shows a block diagram of a system that provides a demographic information page or section, according to an example embodiment.

FIG. 14 shows a block diagram illustrating the operations performed by a system that enables a user to provide a rating for a hotspot provider, according to an example embodiment.

FIG. 15 shows a flowchart for enabling a user to provide a rating for a hotspot provider, according to an example embodiment.

FIG. 16 shows a block diagram of a system that enables user to provide a rating for a hotspot provider, according to an example embodiment.

FIG. 17 shows a block diagram illustrating the operations performed by a system that enables a hotspot provider administrator to obtain and view performance indicator(s).

FIG. 18 shows a flowchart for enabling a hotspot provider administrator to view performance indicator(s) associated with consumer(s) of the hotspot provider, according to an example embodiment.

FIG. 19 shows a block diagram of a system that enables a hotspot provider administrator to view performance indicator(s) associated with consumer(s) of the hotspot provider, according to an example embodiment.

FIG. 20 is a block diagram of a communication system in which server administrator(s) are enabled to view and configure information associated with each of the hotspot providers maintained by the system, according to an example embodiment.

FIG. 21 depicts a main GUI screen that enables a server administrator to view various pieces of information associated with each of the hotspot providers maintained by a system, according to an example embodiment.

FIG. 22 depicts a GUI screen that displays a list of hotspot providers, network devices located at those hotspot providers, and the markets in which those hotspot providers are located, according to an example embodiment.

FIG. 23 depicts a GUI screen that displays a list of advertisement campaigns and various information associated with those advertisement campaigns, according to an example embodiment.

FIG. 24 depicts a GUI screen that displays a list of advertisements and various information associated with those advertisements, according to an example embodiment.

FIG. 25 depicts a GUI screen that displays a list of results for each of the advertisement campaigns, according to an example embodiment.

FIG. 26 depicts a GUI screen that displays a list of details regarding each block for each of the landing pages maintained by a system, according to an example embodiment.

FIG. 27 is a block diagram of an example computer system in which embodiments may be implemented.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### I. Introduction

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

Techniques described herein provide user(s) (e.g., consumers) with a customized landing page that is based on a location (e.g., a business or organization) at which the user is located. The customized landing page may be configured to enable a consumer to access the Internet via an Internet hotspot provided by the business or organization. Businesses and/or organizations that provide Internet hotspots may be referred to as “hotspot providers.” The customized landing page may require the consumer(s) to perform certain actions before enabling a consumer to access the Internet. Such actions include, but are not limited to, viewing advertisements, providing demographic information and/or contact information, and/or interacting with one or more services. The service(s) include, but are not limited to, a rating service that enables a consumer to rate a hotspot provider, a “liking” service that enables a consumer to “like” a hotspot provider, a survey service that enables a consumer to take a survey associated with a hotspot provider, an incentive service that enables a consumer to share an inventive and/or register for an incentive associated a hotspot provider, and/or the like.

Upon connecting to the Internet, various performance indicators associated with the consumer(s) may be determined Examples of performance indicator(s) that may be determined include, but are not limited to, the number of consumers that visit a hotspot provider, the dwell time for consumers visiting a hotspot provider, the percentage of consumers that are return consumers of a hotspot provider, the demographic makeup of consumers of a hotspot provider, a collection of contact information (e.g., e-mail addresses, phone numbers, addresses, and/or the like) for consumers of a hotspot provider, etc.

In accordance with an embodiment, an administrator of a hotspot provider may be enabled to view the performance indicator(s) and market themselves accordingly.

### II. Example Systems and Methods for Providing a Customized Landing Page

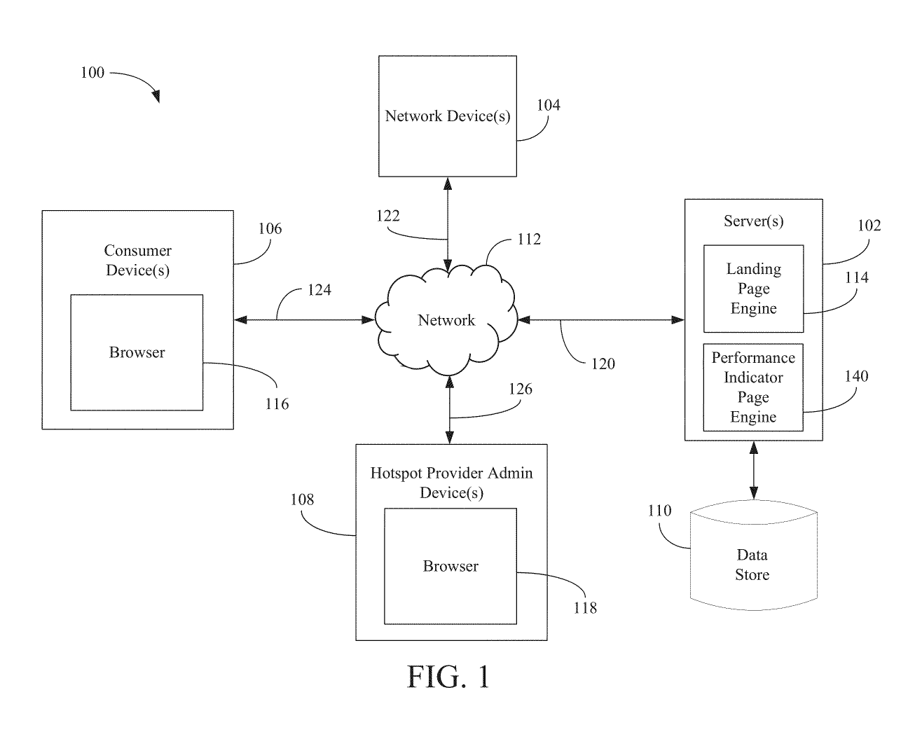

FIG. 1 is a block diagram of a communication system 100 in which users are provided with a customized landing page that enables a user (e.g., a consumer) to connect to the Internet via a hotspot provided by a hotspot provider, according to an example embodiment. Communication system 100 may also be configured to determine performance indicator(s) associated with consumer(s) of hotspot provider(s), according to another example embodiment. System 100 is shown for purposes of illustration, and embodiments may be implemented in other environments, as would be apparent to persons skilled in the relevant art(s) from the teachings herein. As shown in FIG. 1, system 100 includes a server 102, one or more network devices 104, one or more consumer devices 106, one or more hotspot provider admin device(s) 108, a data store 110, and a network 112. Furthermore, server 102 includes a landing page engine 114 and a performance indicator page engine 140. System 100 is described as follows.

Server 102 may be implemented in one or more computer systems, including one or more servers, which may be any type of computing device described herein or otherwise known that is capable of enabling the corresponding functionality described herein. Consumer device(s) 106 and hotspot provider admin device(s) 108 may each be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a smart phone (e.g., an Apple iPhone, a Google Android™ phone, a Microsoft Windows® phone, etc.), or other type of computing device. Network device(s) 104 may be any type of computing device that enables another computing device (e.g., consumer device(s) 106 and/or hotspot provider admin device(s) 108) to connect to the Internet. In accordance with an embodiment, network device(s) 104 allow wireless devices to connect to a wired networking using a wireless connection (e.g., Wi-Fi). Examples of such network devices include, but are not limited to, wireless access points, routers, and/or the like.

As shown in FIG. 1, server 102, network device(s) 104, consumer device(s) 106, and hotspot provider admin device(s) 108 are communicatively coupled with each other through network 112. Network 112 may be a LAN (local area network), a WAN (wide area network), or any combination of networks, such as the Internet. Server 102 is coupled to network 112 through a communication link 120, network device(s) 104 are coupled with network 112 through a communication link 122, consumer device(s) 106 are coupled with network 112 through a communication link 124, and hotspot provider admin device(s) 108 are coupled with network 112 through a communication link 126. Communication links 120, 122, 124, and 126 may each include wired and/or wireless links. Examples of communication links 120, 122, 124, and 126 include IEEE 802.11 wireless LAN (WLAN) wireless links, Worldwide Interoperability for Microwave Access (Wi-MAX) links, cellular network links, wireless personal area network (PAN) links (e.g., Bluetooth™ links), Ethernet links, USB (universal serial bus) links, etc.

Landing page engine 114 may be configured to provide a customized landing page to consumer device(s) 106 located at a particular Internet hotspot (e.g., a site that offers Internet access over a wireless local area network (WLAN) through the use of a router connected to a link to an Internet service provider). A commercial Internet hotspot provider may refer to any business, organization, etc. that provides Internet access for their consumers (e.g., customers) via a network device (e.g., network device 104) located at the Internet hotspot. Examples of such businesses and organizations include, but are not limited to, restaurants, airports, libraries, hotels, coffee shops, bookstores, department stores, supermarkets, and various other public establishments.

The landing page provided to consumer device(s) 106 may be a Web page that a consumer interacts with to gain access to the Internet. The landing page may be hosted by server 102. The landing page may be the first web page that is provided to and displayed by consumer device(s) 106 when a consumer, via the consumer device, connects to a network device (e.g., network device(s) 104) located at the hotspot provider. The consumer device is prevented from accessing other Web pages or Web sites on the Internet until the consumer performs additional actions via the landing page (i.e., the consumer is in a “walled garden” until the consumer performs these other actions).

In accordance with an embodiment, the landing page provided to consumer device (s) 106 may be customized based on the location (e.g., the business, organization, etc.) at which consumer device(s) 106 are located. The landing page may be a standard landing page or an advanced (i.e., premium) landing page depending on the location. A standard landing page may be a landing page that has minimal information about the business or organization at which the network device is located. The advanced landing page may be a landing page that includes additional features that are not available on a standard landing page. For example, an advanced landing page may include one or more services that a user may interact with. Examples of such services include, but are not limited to a rating service that enables a consumer to rate the location at which the hotpot is provided, a “liking” service that enables a consumer to “like” the location at which the hotpot is provided via a social network, a survey service that enables a consumer to take a survey associated with the location at which the hotspot is provided, an incentive service that enables a consumer to share an incentive (e.g., a deal, coupon, etc.) associated with the location at which the hotspot is provided and/or register for the incentive, etc.

The type of landing page (i.e., a standard landing page or an advanced landing page) provided to consumer device(s) 106 and/or the types of services provided by the advanced landing page may be determined and configured by each business or organization providing a hotspot (e.g., via hotspot provider admin device(s) 108).

In accordance with another embodiment, a standard landing page and/or a premium landing page may include one or more advertisements. The advertisements) may also be customized based on the location at which the consumer device is located.

In accordance with yet another embodiment, the landing page may enable a consumer to enter in demographic information and/or contact information regarding himself.

It is noted that a landing page (e.g., a standard landing page or an advanced landing page) may comprise a plurality of sections containing different content and/or a plurality of Web pages, where each of the plurality of Web pages contains different content. For example, as described below, standard landing pages and/or advanced landing pages may include an advertisement page or section, and advanced landing pages may additionally include a demographic information page or section, a service page or section, etc. Each of these pages or sections are described in greater detail below.

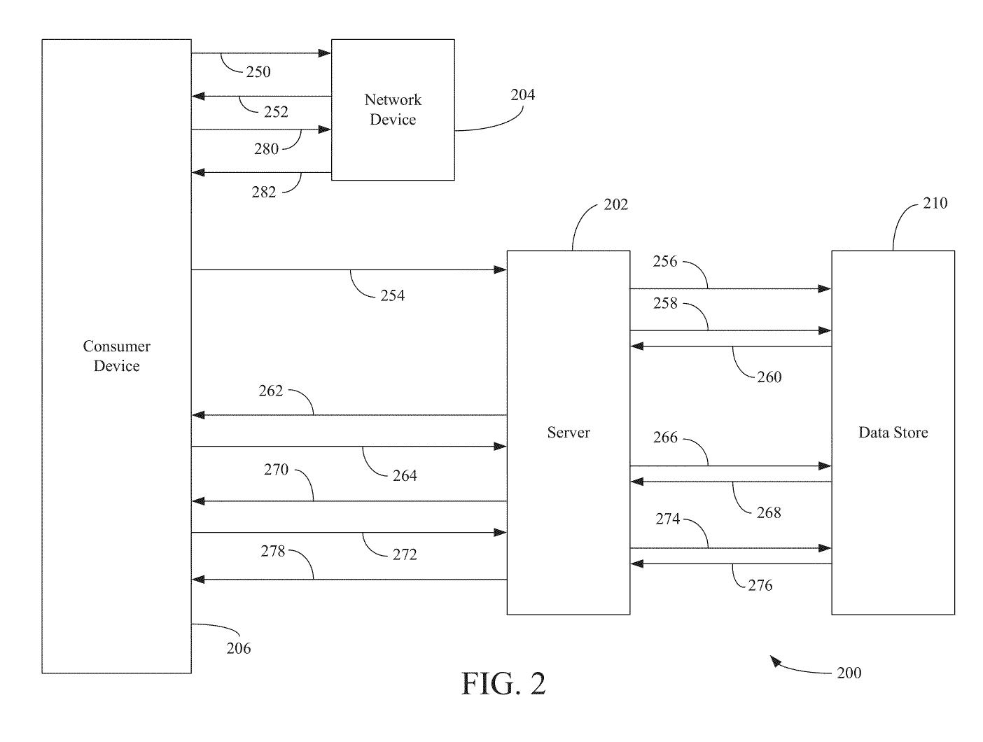

Data store 110 may comprise a database that is configured to store information associated with each of consumer device(s) 106, network device(s) 104, and/or the hotspot provider(s) associated with network device(s) 104. For example, data store 110 may store a set of parameter(s) associated consumer device(s) 106 (described below with reference to FIG. 2) and a set of parameter(s) associated with network device(s) (described below with reference to FIG. 2). Data store 110 may be further configured to store landing page customizations and/or settings for each hotspot provider. Examples of page customizations and/or settings include, but are not limited to, the service(s) that a consumer is able to interact with, the types of demographic information that are collected for each consumer, the types of contact information collected for each consumer, etc.

Consumer device(s) 106 may include a client that enables a user to access, view, and/or interact with Web sites that are hosted by server 102 (e.g., a landing page) or Web sites that are hosted by other server(s) (not shown). For instance, a client may be a Web browser or any other suitable type of client. As shown in FIG. 1, consumer device(s) 106 includes a browser 116.

Each of hotspot provider admin device(s) 108 may include a client that enables an administrator of a hotspot provider to select the type of landing page to be provided to its consumers, select and configure service(s) to be included in a landing page (if a premium landing page is to be provided), select advertisement(s) to be displayed via a landing page, select the demographic information to be collected from consumer(s), and/or view various attributes associated with consumers that have accessed a hotspot. For instance, a client may be a Web browser or any other suitable type of client. As shown in FIG. 1, hotspot provider admin device(s) 108 includes a browser 118.

Browser 116 and/or browser 118 may be software applications that are configured to retrieve, present, and traverse network-accessible content, such as Web sites provided by server 102 or other server(s). Some well-known Web browsers include Internet Explorer® (published by Microsoft Corporation of Redmond, Wash.), Firefox® (published by Mozilla Corporation of Mountain View, Calif.), and Chrome™ (published by Google Inc. of Mountain View, Calif.).

FIG. 2 shows a block diagram 200 illustrating the operations performed by a system 200 that enables a consumer device to connect to the Internet via a customized landing page, according to an example embodiment. As shown in FIG. 2, block diagram 200 includes a server 202, a network device 204, a consumer device 206, and a data store 210. Server 202 is an example of server 102, network device 204 is an example of network device 104, consumer device 206 is an example of consumer device 106, and data store 210 is an example of data store 110.

The operations shown in FIG. 2 may occur when a consumer visits a particular hotspot provider. Upon visiting the hotspot provider, the consumer may have the desire to browse the Internet using his consumer device 206. To connect to a network (e.g., a Wi-Fi network) provided by the hotspot provider, consumer device 206 may send a request 250 to network device 204. Request 250 may be a request for network access. Consumer device 206 may send request 250 in response to a consumer selecting the network provided by network device 204 using consumer device 206 or in response to the consumer attempting to access the Internet using a browser (e.g., by entering in a URL in the browser) executing on consumer device 206.

In response to receiving request 250, network device 204 may send a response 252 to consumer device 206. Response 252 may include one or more parameters associated with network device 204. Examples of such parameter(s) include, but are not limited to, a gateway identification (ID) of network device 204, a node ID of network device 204, a node media access control (MAC) address of network device 204, and/or any other identifier that uniquely identifies network device 204. The parameter(s) may also include an authentication key, which may be used to authenticate consumer device 206 with network device 204. Response 252 may also instruct consumer device 206 to request a landing page from server 202.

Accordingly, as shown in FIG. 2, consumer device 206 provides a request 254 for a landing page to server 202. Request 254 may include the parameter(s) associated with network device 204 (as described above with respect to response 252). Request 254 may also include parameter(s) associated with consumer device 204. The parameter(s) associated with consumer device 204 include, but are not limited to, the MAC address of consumer device 206, an Internet Protocol (IP) address of consumer device 206, and/or any identifier that uniquely identifies consumer device 206. In the case where the consumer attempted to access the Internet by entering in a URL in the browser, request 254 may also include that URL.

In response to receiving request 254, server 202 may provide the parameter(s) associated with consumer device 206 and/or network device 204 (e.g., parameters 256) to data store 210. Data store 210 may store parameter(s) 256 for future use.

Based on the parameter(s) received via request 254, server 202 may determine the type of landing page (e.g., a standard landing page or an advanced landing page) to be provided to consumer device 206. For example, server 202 may access a data structure (e.g., a table) that defines an association between the parameter(s) and the type of landing page to be provided based on those parameter(s). The association may be defined by a hotspot provider administrator via hotspot provider admin device 108, as shown in FIG. 1.

Server 202 may also be configured to retrieve page customizations and/or settings that are used to generate the landing page to be provided to consumer device 206. For example, server 202 may formulate and send a query 258 based on the parameter(s) associated with network device 204 and/or consumer device 206 to data store 210. In response, data store 210 may return a response 260 that includes the page customizations and/or settings associated with the parameters. Examples of page customizations and/or settings include, but are not limited to, a demographic information section page or section and/or a service page or section, each of which are described below in greater detail.

Server 202 may then generate the landing page (i.e., either a standard landing page or an advanced landing page) based on the received page customizations and/or settings and provide the generated landing page (e.g., landing page 262) to consumer device 206.

In accordance with an embodiment, landing page 262 includes a terms of services section that describes rules that a user must agree to abide by in order to gain access to the Internet. A consumer may be enabled to accept or reject the terms of service via an interface element included in landing page 262. If the consumer rejects the terms of service, the consumer is not granted Internet access. On the other hand, if the consumer accepts the terms of service, consumer device 206 provides an acceptance 264 to server 202.

In response to receiving acceptance 264, server 202 may query data store 210 for advertisement(s) associated with the hotspot provider. For example, as shown in FIG. 2, server 202 may formulate and provide a query 266 based on the parameter(s) associated with network device 204 and/or consumer device 206 to data store 210. In response to receiving query 266, data store 210 may return a response 268 that includes advertisement(s) associated with the hotspot provider. Upon receiving the advertisement(s), server 202 may provide an advertisement page or section 270 (e.g., a Web page or portion thereof) that contains the advertisement(s).

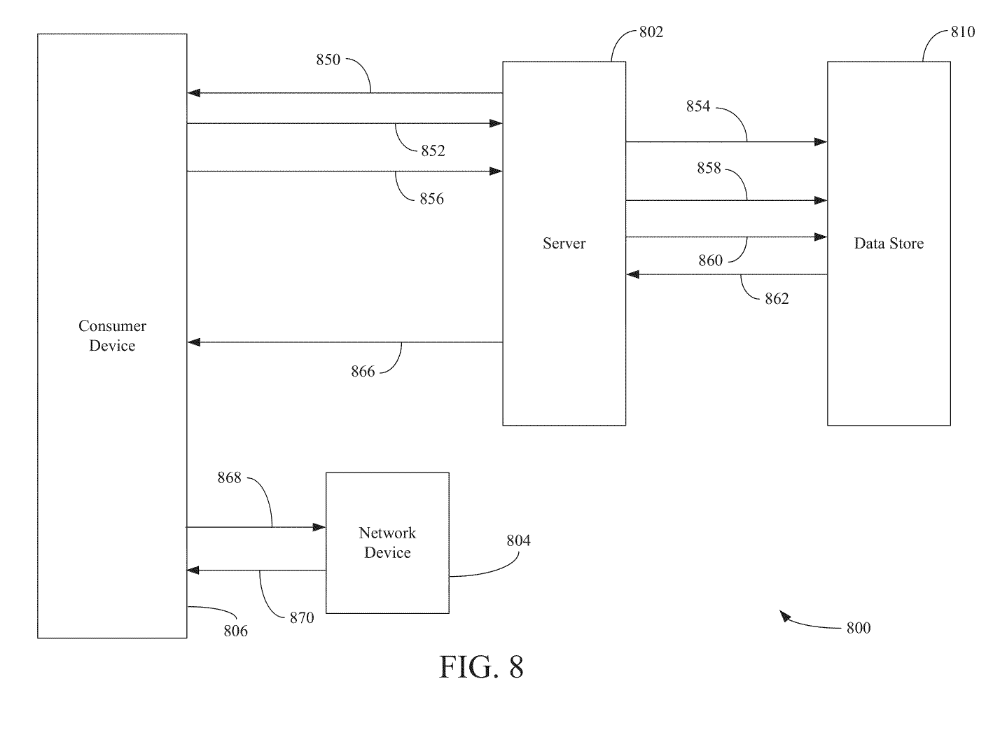

In accordance with an embodiment, consumer(s) may be enabled to select (e.g., click on) the advertisement(s). In response to selecting an advertisement, consumer device 206 may be redirected to the advertiser's Web page. Server 202 may further be configured to determine one or more metrics associated with the advertisement(s). Such metric(s) include, but are not limited to, whether a consumer has viewed an advertisement, whether a consumer has selected an advertisement, and/or whether the selection of an advertisement resulted in a conversion. Additional details regarding such operations are described below with reference to FIGS. 8-10,

Advertisement page or section 270 may further include an interface element (e.g., a “Connect” button), which, when activated, enables consumer device 206 to access the Internet. In accordance with an embodiment, a consumer may be prevented from activating the “Connect” button for a predetermined time period (e.g., 10 seconds) in order to ensure that the consumer has an opportunity to view and/or select the advertisement(s). Once the predetermined time period has expired, the user may be enabled to activate the “Connect” button.

As shown in FIG. 2, upon activating the “Connect” button, consumer device 206 may provide an indication 272 that indicates that the user has activated the “Connect” button to server 202. In response, server 202 may provide a query 274 to data store 210 to obtain the authentication key included in parameter(s) 256. Data store 210 may be configured to provide a response 276 that includes the authentication key to server 202. In response to receiving the authentication key, server 202 may provide an instruction 278 that includes the authentication key to consumer device 206. Instruction 278 may cause consumer device 206 to provide an authentication request 280 that includes the authentication key to network device 204.

Network device 204 may be configured to authenticate consumer device 206 in response to receiving authentication request 280. After authenticating consumer device 206 using the authentication key, network device 204 may be configured to provide an instruction 282 to consumer device 206, which enables consumer device 206 to access the Internet (i.e., the consumer device 206 is no longer in the “walled garden”).

In the case where the consumer attempted to access the Internet by entering in a URL in the browser, server 202 may be configured to query data store 210 to retrieve the URL included in parameter(s) 256 and include the URL in an instruction (e.g., instruction 278) that is provided to consumer device 206. Upon being authenticated by network device 204, the browser executing on consumer device 206 may be automatically redirected to the URL.

A. Enabling a Consumer to Interact with Service(s) and Providing Access to the Internet in Response to a User Interacting with the Service(s)

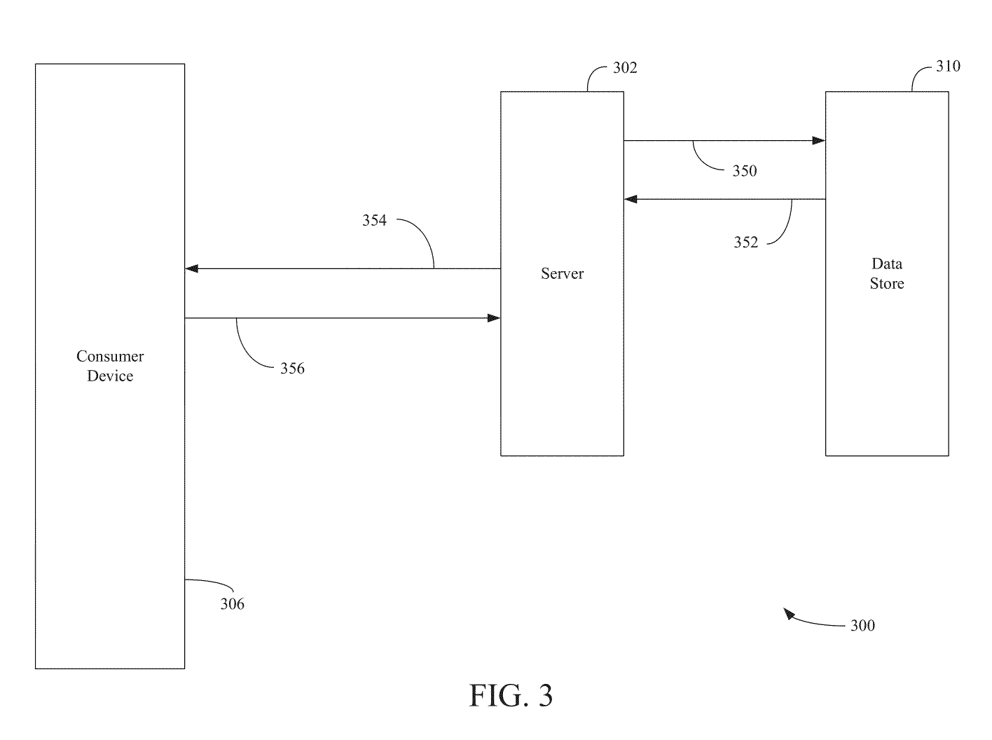

As described above, an advanced landing page may enable a consumer to interact with service(s). Accordingly, FIG. 3 shows a block diagram illustrating the operations performed by a system 300 to enable a consumer to interact with service(s), according to an example embodiment. As shown in FIG. 3, system 300 includes a server 302, a consumer device 306, and a data store 310. Server 302 is an example of server 102 or 202, consumer device 306 is an example of consumer device(s) 106 or 206, and data store 310 is an example of data store(s) 110 or 210, as respectively shown in FIGS. 1 and 2. In accordance with an embodiment, the operations shown in FIG. 3 may occur after the user has accepted the terms of service, and may occur before (or in lieu of) the provision of advertisements to the consumer device.

Accordingly, as shown in FIG. 3, server 306 may be configured to formulate and send a query 350 to data store 310 for service(s) that are associated with the hotspot provider at which the consumer is located. Query 350 may be based on one parameter(s) (e.g., parameters 256, as shown in FIG. 2). In response to receiving query 350, data store 310 may provide a response 352 that includes interface element(s) that enable the consumer to interact with service(s). Examples of service(s) include, but are not limited to a rating service that enables a consumer to rate the hotspot provider, a “liking” service that enables a consumer to “like” the hotspot provider via a social network, a survey service that enables a consumer to take a survey associated with the hotspot provider, an incentive service that enables a consumer to share an incentive (e.g., a deal, coupon, etc.) associated with the hotspot provider and/or register for the incentive, etc.

Server 302 may be configured to generate a service page or section 354 that includes the interface element(s) and provide service page or section 354 to consumer device 306. A user may be enabled to interact with the service(s) by activating the interface element(s) via consumer device 406. Examples of service interaction include, but are not limited to, rating the hotspot provider (if a rating service is provided) using the interface element(s), “liking” the hotspot provider (if a “liking” service is provided) using the interface element(s), taking a survey regarding the hotspot provider (if a survey service is provided) using the interface element(s), and/or sharing and/or registering for an incentive associated with the hotspot provider using the interface element(s) (if an incentive service is provided). Other examples of service interaction include actively not participating in the service(s) (e.g., by closing a window in which service page or section 354 is presented, interacting with an interface element included in service page or section 354 that enables the user to opt-out of participating with the service(s), etc.

Once a user interacts with the service(s) via the interface element(s), consumer device 306 may provide a notification 356 that indicates that the user has interacted with the service(s) to server 302. Thereafter, server 302 may provide advertisements) to consumer device 306, as described above with reference to FIG. 2.

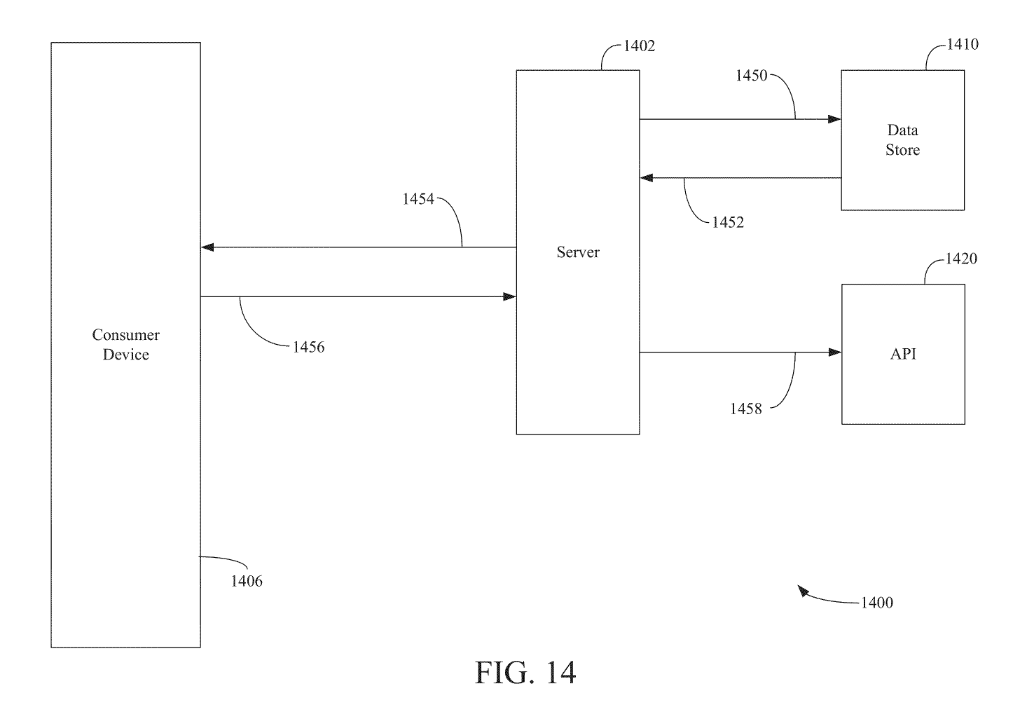

In accordance with an embodiment, if the interaction comprises one of rating a hotspot provider, “liking” a hotspot provider, taking a survey regarding a hotspot provider, and/or sharing and/or registering for an incentive associated with a hotspot provider, server 302 may be configured to provide the notification to the service (e.g., a third-party service) via an application programming interface (API). Additional details regarding providing the notification via an API is described below with reference to FIGS. 14-16.

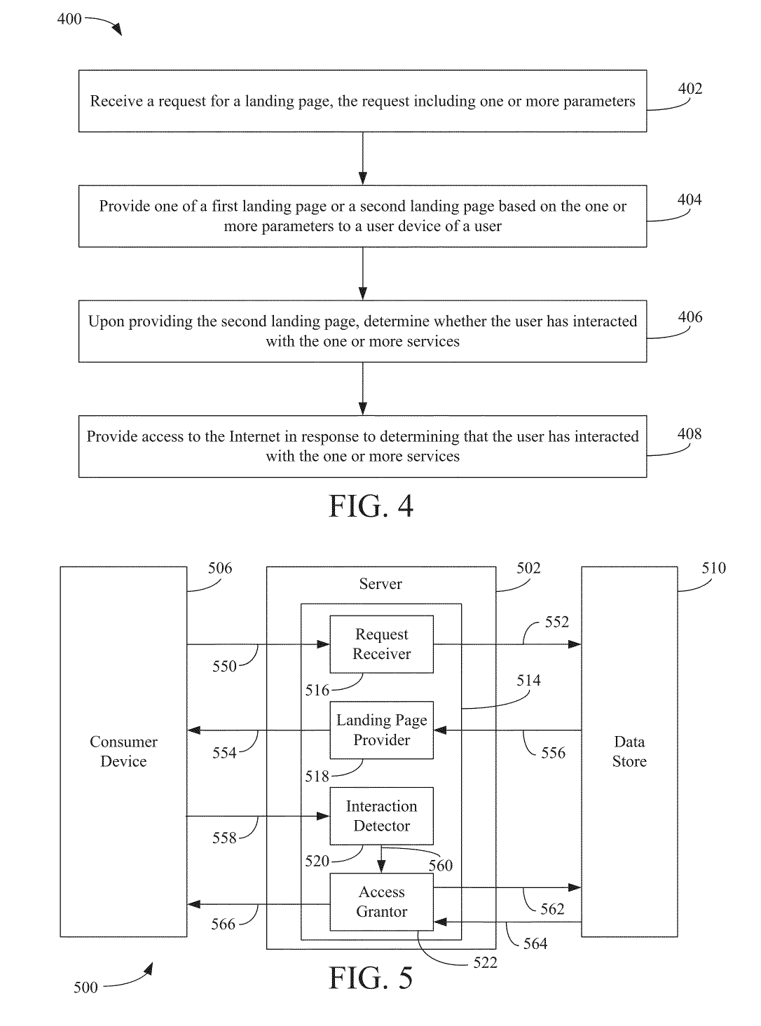

In accordance with an embodiment, access to the Internet via a hotspot may be conditioned on a user interacting with service(s). For instance, FIG. 4 shows a flowchart 400 for providing conditional access to the Internet via a hotspot based on whether a user has interacted with service(s) via a landing page, according to an example embodiment. In an embodiment, systems 100, 200, and 300 may operate according to flowchart 400. Furthermore, FIG. 5 shows a block diagram of system 500, according to an example embodiment. System 500 is an example of system 100, 200, or 300. As shown in FIG. 5, system 500 includes server 502, consumer device 506, and data store 510. Server 502 includes landing page engine 514. Landing page engine 514 includes a request receiver 516, a landing page provider 518, an interaction detector 520, and an access grantor 522. Server 502, consumer device 506, and data store 510 are examples of server 102, 202, or 302, consumer device 106, 206, or 306, and data store 110, 210, or 310, as respectively shown in FIGS. 1-3. Landing page engine 514 is an example of landing page engine 114, as shown in FIG. 1. Flowchart 400 is described with respect to system 500 for illustrative purposes. Further structural and operational embodiments will be apparent to persons skilled in the relevant art(s) based on the following description of flowchart 400 and system 500.

Flowchart 400 begins with step 402. In step 402, a request for a landing page is received. The request may include one or more parameters. For example, in an embodiment, request receiver 516 receives request 550 for a landing page associated with a hotspot provider from consumer device 506.

In accordance with an embodiment, the parameter(s) included in request 550 may include parameters associated with a network device (not shown) to which consumer device 406 is connected. The network device may be associated with the hotspot provider. Example of parameters associated with the network device include, but are not limited to, a gateway ID of the network device, a node ID of the network device, a node MAC address of the network device, and/or any other identifier that uniquely identifies the network device. The parameter(s) may also include an authentication key, which may be used to authenticate consumer device 506 with the network device. The parameter(s) may also include parameters associated with consumer device 506. Such parameters include, but are not limited to, the MAC address of consumer device 506, an IP address of consumer device 506, and/or any identifier that uniquely identifies consumer device 506. In the case where the consumer attempted to access the Internet by entering in a URL in a browser executing on consumer device 506, the parameter(s) may also include that URL.

Upon receiving request 550, request retriever 516 may be configured to formulate and provide a query 552 for page customizations and/or settings associated with the hotspot provider to data store 510. Query 552 may be based on the parameter(s). In response to receiving query 552, data store 510 may provide a response 556 that includes the page customizations and/or settings for the hotspot provider to server 502.

In step 404, one of a first landing page or a second landing page is provided based on the parameter(s) to a user device of a user. For example, in an embodiment, landing page provider 518 receives page customizations and/or settings 556 that are based on the parameter(s) and generates a landing page 554 based on page customizations and/or settings 556. Landing page 554 may either be a first landing page (e.g., a standard landing page) or a second landing page (e.g., an advanced landing page) depending on page customizations and/or settings 556. Landing page provider 518 provides the generated landing page (e.g., landing page 554) to consumer device 506.

In accordance with an embodiment, the second landing page enables the user to interact with service(s) that are associated with the hotspot provider, and the first landing page does not enable the user to interact with the one or more services. For example, the advanced landing page may include a service page or section that includes interface element(s) that enable a consumer to interact with service(s). Examples of such services may include, but are not limited to a rating service that enables a consumer to rate the hotspot provider, a “liking” service that enables a consumer to “like” the hotspot provider via a social network, a survey service that enables a consumer to take a survey associated with the hotspot provider, an incentive service that enables a consumer to share an incentive associated with the hotspot provider and/or register for the incentive, etc.

In step 406, upon providing the second landing page, a determination is made as to whether the user has interacted with the service(s). For example, in an embodiment, upon providing an advanced landing page that includes a service page or section, interaction detector 520 may be configured to determine whether a consumer has interacted with the interface element(s). For instance, when a consumer interacts with the interface element(s), consumer device 506 may provide an indicator 558 that indicates that a consumer has interacted with the service(s) to interaction detector 520.

In step 408, access to the Internet is provided in response to determining that the user has interacted with the service(s). For example, in an embodiment, in response to receiving indicator 558, interaction detector 520 may provide a notification 560 to access grantor 522. Notification 560 may cause access grantor 522 to send a query 562 for an authentication key to data store 510. In response, data store 510 may provide a response 564 that includes the authentication key. Access grantor 522 may then provide an instruction 566 that includes the authentication key to consumer device 506. Instruction 566 may cause consumer device 506 to send an authentication request to a network device (not shown), which then authenticates consumer device 506 using the authentication key and enables consumer device 506 to access the Internet in a manner described above with reference to FIG. 2.

B. Providing Access to the Internet after the Provision of Advertisement(s)

In accordance with an embodiment, in response to receiving indicator 558, server 502 may be configured to retrieve advertisements for display on consumer device 506. Consumer device 506 may be enabled to access the Internet after the provision of the advertisements.

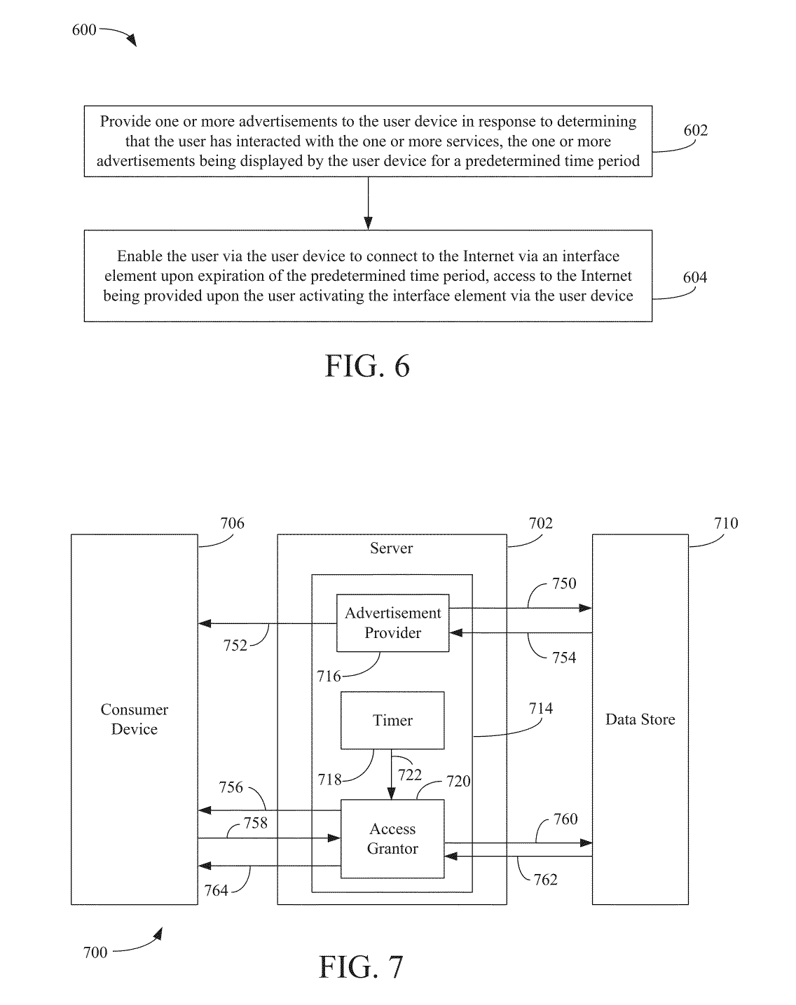

For instance, FIG. 6 shows a flowchart 600 for providing access to the Internet after the provision of advertisement(s), according to an example embodiment. In an embodiment, systems 100, 200, and 300 may operate according to flowchart 600. Furthermore, FIG. 7 shows a block diagram of system 700, according to an example embodiment. System 700 is an example of system 100, 200, or 300. As shown in FIG. 7, system 700 includes server 702, consumer device 706, and data store 710. Server 702 includes landing page engine 714. Landing page engine 714 includes an advertisement provider 716, a timer 718, and an access grantor 720. Server 702, consumer device 706, and data store 710 are examples of server 102, 202, or 302, consumer device 106, 206, or 306, and data store 110, 210, or 310 as respectively shown in FIGS. 1-3. Landing page engine 714 is an example of landing page engine 114 or landing page engine 314, as respectively shown in FIGS. 1 and 3. Flowchart 600 is described with respect to system 700 for illustrative purposes. Further structural and operational embodiments will be apparent to persons skilled in the relevant art(s) based on the following description of flowchart 600 and system 700.

Flowchart 600 begins with step 602. In step 602, one or more advertisements are provided to the user device in response to determining that the user has interacted with the one or more services. The advertisement(s) may be displayed by the user device for a predetermined time period. For example, in an embodiment, advertisement provider 716 may provide an advertisement page or section 752 that includes advertisement(s) to consumer device 706. The advertisements may be retrieved from data store 710. For example, advertisement provider 716 may formulate a query 750 based on parameter(s) (e.g., parameters 256, as shown in FIG. 2) and send query 750 to data store 710. In response to receiving query 750, data store may provide a response 754 that includes the advertisement(s) to server 702.

In step 604, the user is enabled via the user device to connect to the Internet via an interface element upon expiration of the predetermined time period. Access to the Internet may be provided upon the user activating the interface element via the user device. For example, access grantor 720 may enable the consumer via consumer device 706 to connect to the Internet via an interface element included in advertisement page or section 752 upon expiration of the predetermined time period.

In an embodiment, timer 718 may specify the predetermined time period for which the advertisement(s) are displayed by consumer device 706. Upon expiration of the predetermined time period, timer 718 may provide a notification 722 to access grantor 720. Upon receiving notification 722, access grantor 720 may send an instruction 756 to consumer device 706 that enables an interface element (e.g., a “Connect” button) included in advertisement page 752 to be activated by the consumer. When activated by the consumer, consumer device 706 may provide a notification 758 that indicates that the consumer has activated the interface element to access grantor 720.

Notification 758 may cause access grantor 720 to send a query 760 for an authentication key to data store 710 based on parameters (e.g., parameters 256, as shown in FIG. 2). In response, data store 710 may provide a response 762 that includes an authentication key associated with the network device of the hotspot provider. Access grantor 720 may then provide an instruction 764 that includes the authentication key to consumer device 706. Instruction 764 may cause consumer device 706 to send an authentication request to the network device (not shown), which authenticates consumer device 706 and enables consumer device 706 to access the Internet in a manner described above with reference to FIG. 2.

C. Determining Metric(s) Associated with Advertisement(s)

In accordance with an embodiment, metric(s) associated with the advertisements) that are provided to a consumer device are determined. Such metric(s) may include, but are not limited to, whether or not the advertisement(s) have been viewed, whether or not the advertisement(s) have been selected (e.g., clicked on), a click-through rate associated with the advertisements, a conversion rate associated with the advertisements, etc.

Accordingly, FIG. 8 shows a block diagram illustrating the operations performed by a system 800 that determines metric(s) associated with advertisement(s), according to an example embodiment. As shown in FIG. 8, system 800 includes a server 802, a consumer device 806, and a data store 810. Server 802 is an example of server 102, 202, or 302, consumer device 806 is an example of consumer device(s) 106, 206, or 306 and data store 810 is an example of data store(s) 110, 210, or 310. In accordance with an embodiment, the operations shown in FIG. 8 may occur after server 802 has retrieved advertisements from data store 810, as described above with reference to FIGS. 2, 6, and 7.

As shown in FIG. 8, server 806 may be configured to provide an advertisement page 850 that includes advertisements) to consumer device 806. Upon displaying the advertisement(s), consumer device 806 may provide a notification 852 indicating that the advertisements) have been displayed on consumer device 806 (i.e., viewed by the consumer) to server 802. Server 802 may store an indication 854 for each of the advertisement(s) that have been viewed in data store 810.

For each advertisement that a consumer selects, consumer device 806 may provide a notification 856 indicating that the consumer has selected the advertisement to server 802. Server 802 may store indication(s) 858 for each advertisement that has been selected in data store 810.

Server 806 may further be configured to send a query 860 to data store to retrieve a resource identifier (e.g., a URL) that is associated with the advertisement that has been selected, along with an authentication key associated with network device 804, which is associated with the hotspot provider. The resource identifier may correspond to a Web page of an advertiser that provided the advertisement. In response to receiving query 860, data store 810 may provide a response 862 that includes the resource identifier and the authentication key to server 802.

In response to receiving the resource identifier and the authentication key, server 802 may provide an instruction 866 that includes the resource identifier and the authentication key to consumer device 806. Instruction 866 may cause consumer device 806 to provide an authentication request 868 that includes the authentication key to network device 804.

Network device 804 may be configured to authenticate consumer device 806 using the authentication key in response to receiving authentication request 868. After authenticating consumer device 806 using the authentication key, network device 804 may provide an instruction 870 to consumer device 806, which causes a browser executing on consumer device 806 to be directed to the advertiser's Web page as specified by the resource identifier.

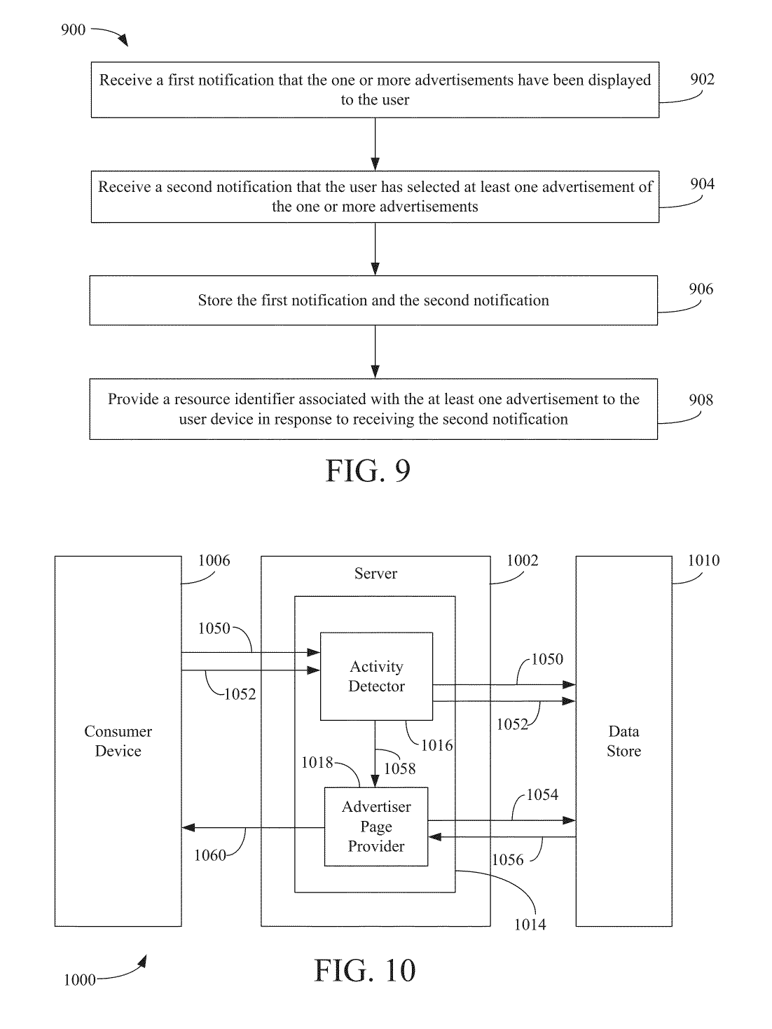

In embodiments, system 800 may operate in various ways to determine metric(s) associated with advertisement(s). For instance, FIG. 9 shows a flowchart 900 for determining metric(s) associated with advertisement(s), according to an example embodiment. In an embodiment, system 800 may operate according to flowchart 900. Furthermore, FIG. 10 shows a block diagram of system 1000, according to an example embodiment. System 1000 is an example of systems 100, 200, 300, or 800. As shown in FIG. 10, system 1000 includes a server 1002, a consumer device 1006, and a data store 1010. Server 1002 includes landing page engine 1014. Landing page engine 1014 includes an activity detector 1016 and an advertiser page provider 1018. Server 1002, consumer device 1006, and data store 1010 are examples of server 102, 202, 302, or 802, consumer device 106, 206, 306, or 806, and data store 110, 210, 310, or 810, as respectively shown in FIGS. 1-3 and 8. Landing page engine 1014 is an example of landing page engine 114, as shown in FIG. 1. Flowchart 900 is described with respect to system 1000 for illustrative purposes. Further structural and operational embodiments will be apparent to persons skilled in the relevant art(s) based on the following description of flowchart 900 and system 1000.

Flowchart 900 begins with step 902. In step 902, a first notification that the one or more advertisements have been displayed to the user is received. For example, in an embodiment, activity detector 1016 receives a first notification 1050 that advertisement(s) have been viewed by a consumer via consumer device 1006.

In step 904, a second notification that the user has selected at least one advertisement of the one or more advertisements is received. For example, in an embodiment, activity detector 1016 receives a second notification 1052 indicating that a consumer, via consumer device 1006, has selected one of the advertisement(s) displayed by consumer device 1006.

In step 906, the first notification and the second notification are stored. For example, in an embodiment, activity detector 1016 stores first notification 1050 and second notification 1052 in data store 1010.

In step 908, a Web page associated with the at least one advertisement is provided to the user device in response to receiving the second notification. For example, in an embodiment, in response to receiving second notification 1052, activity detector 1016 may send a notification 1058 to advertiser page provider 1018. In response, advertiser page provider 1018 may send a query 1054 to data store 1010 for a resource identifier associated with the selected advertisement (e.g., a URL associated with the advertiser providing the advertisement). Data store 1010 provides a response 1056 that includes the resource identifier to advertiser page provider 1018. Advertiser page provider 1018 may provide the resource identifier (e.g., resource identifier 1060) to consumer device 1006. A browser executing on consumer device 1006 may then be redirected to a Web page corresponding to resource identifier 1060 after being authenticated by a network device, as described above with reference to FIG. 8.

D. Determining Demographic Information Associated with Consumer(s)

In accordance with an embodiment, demographic information associated with consumer(s) may be determined. Such demographic(s) may include, but are not limited to age, gender, location, interests, etc.

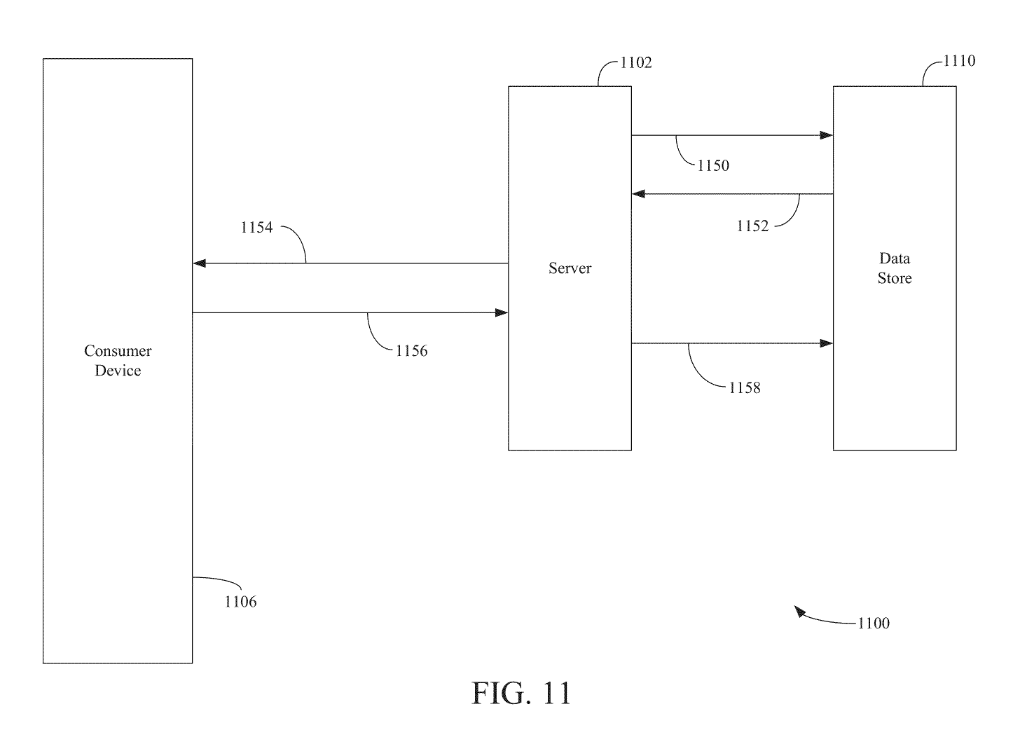

Accordingly, FIG. 11 shows a block diagram illustrating the operations performed by a system 1100 that determines demographic information associated with consumer(s), according to an example embodiment. As shown in FIG. 11, system 1100 includes a server 1102, a consumer device 1106, and a data store 1110. Server 1102 is an example of server 102, 202, 302, or 802, consumer device 1106 is an example of consumer device(s) 106, 206, 306, or 806, and data store 1110 is an example of data store(s) 110, 210, 310, or 810, as respectively shown in FIGS. 1-3, 8, and 11. In accordance with an embodiment, the operations shown in FIG. 11 may occur after the user has accepted the terms of service, but before the provision of advertisements to a consumer device.

As shown in FIG. 11, server 1106 may be configured provide a query 1150 based on parameter(s) (e.g., parameters 256, as shown in FIG. 2) to data store 1110 for demographic attributes associated with the hotspot provider. Each demographic attribute associated with a location represents a type of demographic information to be collected for consumer(s) at that hotspot provider. A set of demographic attribute(s) may be stored for each hotspot provider maintained by data store 110. Each hotspot provider may be associated with a different set of demographic attributes. For example, a first business or organization may only want to collect the age and gender of its consumers, whereas a second business or organization may only want to collect the age and interests of its consumers.

In response to receiving query 1150, data store 1110 provides a response 1152 to server 1102 that includes demographic attribute(s). In response, server 1102 generates a demographic information page or section (e.g., demographic information page or section 1154) based on the demographic attribute(s) and provides demographic information page 1154 to consumer device 1106. For example, if the demographic attribute(s) correspond to an age and gender, server 1106 generates a demographic information page or section that includes interface elements that enable a consumer to enter in his age and gender. Similarly, if the demographic attribute(s) correspond to location and interests, server 1106 generates a demographic information page or section that includes interface elements that enable a consumer to enter in information pertaining to his address (e.g., street name, city name, zip code, etc.) and his interests.

In accordance with an embodiment, some hotspot providers may be designated for demographic information collection and some hotspot providers may not be designated for demographic information collection. In accordance with such an embodiment, server 1106 may query data store 1110 to determine whether or not any demographic attributes are associated with a particular hotspot provider. If no demographic attributes are associated with the particular hotspot provider, then server 1106 may determine that no demographic information page or section is to be provided to consumer device 1106. If demographic attribute(s) are associated with the particular hotspot provider, then server 1106 may determine that a demographic information page or section is to be provided to consumer device 1106.

In response to receiving demographic information page 1156, a consumer, via consumer device 1106, may enter in the requested demographic information. Upon submitting the demographic information, consumer device 1106 may provide a notification 1156 that indicates that the consumer has submitted the demographic information to server 1102. In response to receiving notification 1156, server 1102 may store the demographic information (e.g., demographic information 1158) in data store 1110.

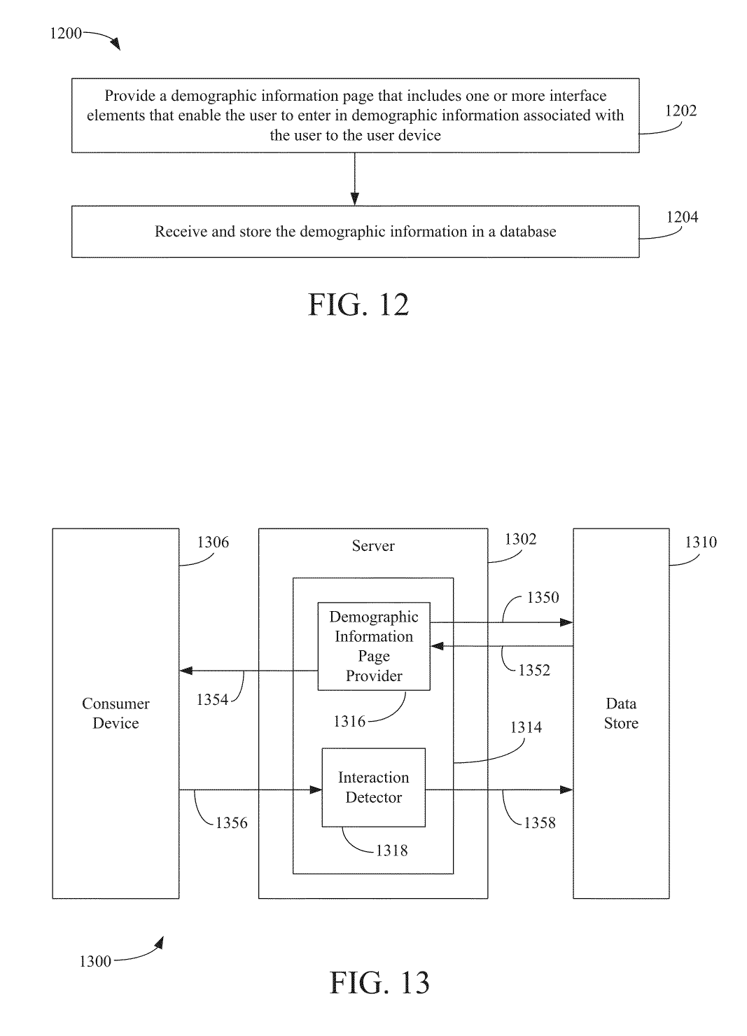

In embodiments, system 1100 may operate in various ways to provide a demographic information page or section. For instance, FIG. 12 shows a flowchart 1200 for providing a demographic information page or section, according to an example embodiment. In an embodiment, system 1100 may operate according to flowchart 1200. Furthermore, FIG. 13 shows a block diagram of system 1300, according to an example embodiment. System 1300 is an example of systems 100, 200, 300, 800, or 1100. As shown in FIG. 13, system 1300 includes a server 1302, a consumer device 1306, and a data store 1310. Server 1302 includes a landing page engine 1314. Landing page engine 1314 includes a demographic information page provider 1316 and an interaction detector 1318. Server 1302, consumer device 1306, and data store 1310 are examples of server 102, 202, 302, 802, or 1102, consumer device 106, 206, 306, 806, or 1106 and, data store 110, 210, 310, 810, or 1110 as respectively shown in FIGS. 1-3, 8, and 11. Landing page engine 1314 is an example of landing page engine 114, as shown in FIG. 1. Flowchart 1200 is described with respect to system 1300 for illustrative purposes. Further structural and operational embodiments will be apparent to persons skilled in the relevant art(s) based on the following description of flowchart 1200 and system 1300.

Flowchart 1200 begins with step 1202. In step 1202, a demographic information page that includes one or more interface elements that enable the user to enter in demographic information associated with the user is provided to the user device. For example, in an embodiment, demographic information page provider 1316 provides demographic information page or section 1354 to consumer device 1306. Demographic information page provider 1316 may provide demographic information page 1354 by sending a query 1350 to data store 1310 for demographic attribute(s) associated with the hotspot provider. In response, data store 1310 provides a response 1352 that includes the demographic attribute(s) to demographic information page provider 1316. Demographic information page provider 1316 may generate demographic information page or section 1354 based on demographic attribute(s). For example, demographic information page provider 1316 may include one or more interface element(s) in demographic information page 1354, which, when activated, enable a consumer to enter in various demographic information associated with the consumer. Demographic information page provider 1316 may provide demographic information page or section 1354 to consumer device 1306.

In step 1204, demographic information is received and stored in a database. For example, in an embodiment, upon a consumer submitting the demographic information via demographic information page 1354, consumer device 1306 may provide a notification 1356 that includes the demographic information entered by the consumer to interaction detector 1318. In response to receiving notification 1356, interaction detector 1318 may store the demographic information (e.g., demographic information 1358) in data store 1310.

E. Providing a Rating for a Hotspot Provider

As described above with reference to FIG. 3, a consumer may be provided access to the Internet in response to interacting with in a service via an advanced landing page. One such service is a rating service, where consumer(s) are enabled to provide a rating for a hotspot provider. The rating service may comprise a third party service provider (e.g., Yelp™) that publishes the rating on its Web site.

Accordingly, FIG. 14 shows a block diagram illustrating the operations performed by a system 1400 that enables a user to provide a rating for a hotspot provider, according to an example embodiment. As shown in FIG. 14, system 1400 includes a server 1402, a consumer device 1406, a data store 1410, and an API 1420. Server 1402 is an example of server 102, 202, 302, 802 or 1102, consumer device 1406 is an example of consumer device(s) 106, 206, 306, 806, or 1106, and data store 1410 is an example of data store(s) 110, 210, 310, 810 or 1110. In accordance with an embodiment, the operations shown in FIG. 14 may occur after the user has accepted the terms of service, and may occur before (or in lieu of) the provision of advertisements to the consumer device.

As shown in FIG. 14, server 1402 may be configured provide a query 1450 based on parameter(s) (e.g., parameters 256, as shown in FIG. 2) to data store 1410 for interface element(s) associated with a rating service for the hotspot provider. In response to receiving query 1450, data store 1410 may provide a response 1452 to server 1402 that includes the interface element(s). In response, server 1402 generates a service page or section (e.g., service page 1454) using the interface element(s) retrieved from data store 1410 and provides service page or section 1454 to consumer device 1406

In response to receiving service page or section 1454, a consumer, via consumer device 1406, may provide a rating for the location using the interface element(s). Upon submitting the rating, consumer device 1406 may provide a notification 1456 that includes the rating to server 1402. In response to receiving notification 1456, server 1402 may provide the rating (e.g., rating 1458) to a third party service provider via API 1420.

In accordance with an embodiment, if the consumer submits a negative rating, server 1402 may be configured to provide a feedback form to consumer, which enables the user to provide additional information regarding the negative rating. Upon submitting this additional information, the additional information may be provided to server 1402, which then forwards the additional information to the third party service provider via API 1420.

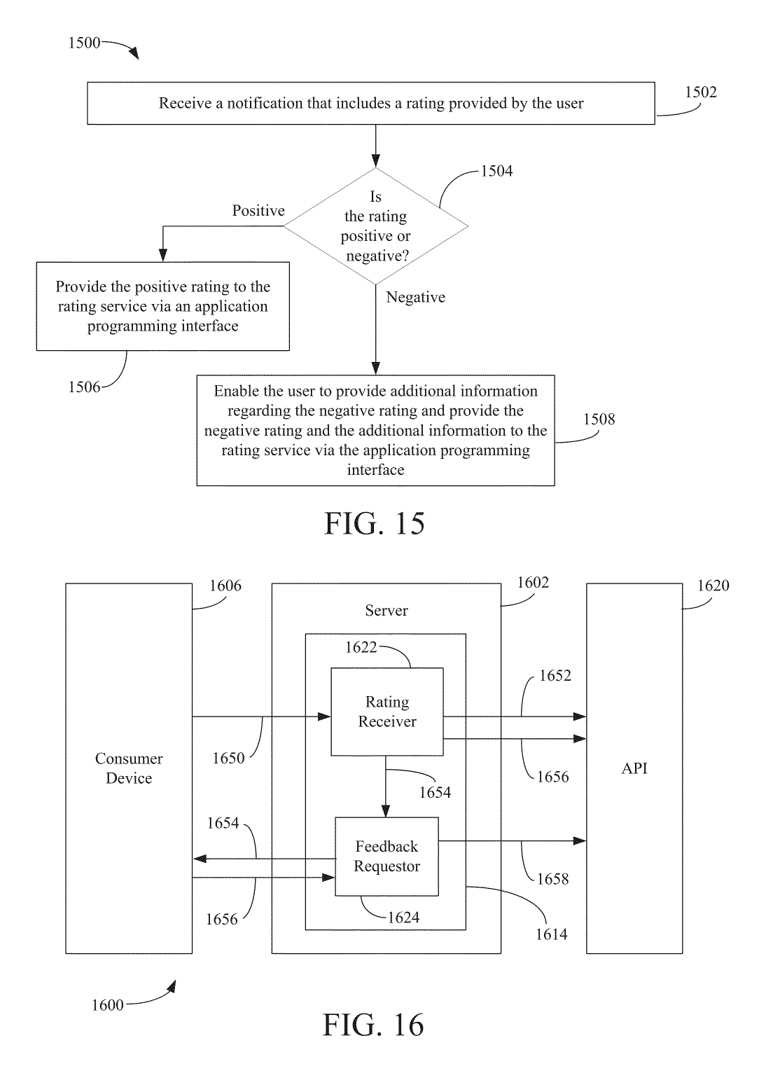

In embodiments, system 1400 may operate in various ways to enable a user to provide a rating for a hotspot provider. For instance, FIG. 15 shows a flowchart 1500 for enabling a user to provide a rating for a hotspot provider, according to an example embodiment. In an embodiment, system 1400 may operate according to flowchart 1500. Furthermore, FIG. 16 shows a block diagram of system 1600, according to an example embodiment. System 1600 is an example of systems 100, 200, 300, 800, 1100, or 1400. As shown in FIG. 16, system 1600 includes a server 1602, a consumer device 1606, and an API 1620. Server 1602 includes landing page engine 1614. Landing page engine 1614 includes a rating receiver 1622 and a feedback requester 1624. Server 1602, consumer device 1606, and API 1620 are examples of server 102, 202, 302, 802, 1102 or 1402, consumer device 106, 206, 306, 806, 1106, or 1406, and API 1420, respectively shown in FIGS. 1-3, 8, 11, and 14. Landing page engine 1614 is an example of landing page engine 114, as shown in FIG. 1. Flowchart 1500 is described with respect to system 1600 for illustrative purposes. Further structural and operational embodiments will be apparent to persons skilled in the relevant art(s) based on the following description of flowchart 1500 and system 1600.

Flowchart 1500 begins with step 1502. In step 1502, a notification that includes a rating provided by the user is received. For example, in an embodiment, rating receiver 1622 receives notification 1650 that includes a rating provided by a consumer from consumer device 1606.

In step 1504, a determination is made as to whether the notification includes a positive rating or a negative rating. For example, in an embodiment, rating receiver 1622 determines whether the notification includes a positive rating or a negative rating. If a determination is made that the notification includes a positive rating, then flow continues to step 1506. Otherwise, flow continues to step 1508.

In step 1506, the positive rating is provided to the rating service via an application programming interface. For example, in an embodiment, rating receiver 1622 provides the positive rating (e.g., positive rating 1652) to a third party rating service via API 1620.

In step 1508, the user is enabled to provide additional information regarding the negative rating, and the negative rating and the additional information are provided to the rating service via the API. For example, in an embodiment, in response to determining that notification 1650 includes a negative rating, rating receiver 1622 may provide a notification 1654 to feedback requester 1624. Notification 1654 may cause feedback requester 1624 to provide a feedback form 1654 to consumer device 1606. A consumer, using consumer device 1606, may be enabled to provide additional information regarding the negative rating using feedback form 1654.

After a user submits the additional information, consumer device 1606 may send a notification 1656 that includes the additional information to feedback requester 1624. Upon receiving the additional information, rating receiver 1622 may provide the negative rating (e.g., negative rating 1656) to the third party service provider via API 1620, and feedback requester 1624 may provide the additional information (e.g., additional information 1658) to the third party service provider via API 1620.

F. Determining and Viewing Performance Indicator(s)

Referring again to FIG. 1, in embodiments, system 100 may be configured to determine performance indicator(s) associated with consumer(s) located at hotspot provider(s) that are maintained by system 100. Examples of performance indicator(s) that are determined include, but are not limited to, the number of consumer(s) that visit hotspot provider(s), the dwell time for consumer(s) visiting hotspot provider(s), the percentage of consumer(s) that are return consumer(s) of hotspot provider(s), the demographic makeup of consumer(s) of hotspot provider(s), a collection of contact information (e.g., e-mail addresses, phone numbers, and/or the like) for consumer(s) of hotspot provider(s), etc.

In accordance with an embodiment, the number of consumer(s) that visit a particular hotspot provider may be determined by a network device (e.g., network device 104) located at the hotspot provider. For example, with reference to FIG. 2, network device 204 may maintain a counter that is incremented each time a new consumer device provides a request 250 to access the network to network device 204. A new consumer device may refer to a consumer device that that has not previously provided a request 250 to network device 204. Network device 204 may provide the value of the counter to server 202, and server 202 may associate the value with the hotspot provider at which network device 204 is located and store the value in data store 210.

In accordance with another embodiment, the number of consumer(s) that visit a particular hotspot provider may be determined by server 202. For example, with reference to FIG. 2, server 202 may maintain a counter that is incremented each time it receives a unique consumer device identifier (e.g., a MAC address, an IP address, or any identifier that uniquely identifies the consumer device) via request 254. Server 202 may associate the value of its counter with the particular hotspot and store the value in data store 210.

The dwell time for consumer(s) visiting hotspot provider(s) may be determined by a network device (e.g., network device 104) located at the hotspot provider. For example, network device 104 may include a timer that is initiated when a consumer device of consumer device(s) 106 connects to a network provided by network device 104. The timer may be terminated when the consumer device is no longer connected to the network provided by network device 104. Network device 104 may provide the value of the timer to server 202, and server 202 may associate the value with the hotspot provider at which network device 204 is located and store the value in data store 210.

In accordance with an embodiment, the percentage of consumer(s) that are return consumer(s) of hotspot provider(s) may be determined by (e.g., network device 104) located at the hotspot provider. For example, with reference to FIG. 2, network device 204 may determine which consumer devices have previously sent a request 250 to network device 204. Network device 204 may determine the percentage of consumer(s) that are return consumer(s) based on such information and the value of its counter as described above. Network device 204 may provide a value corresponding to the percentage of consumer(s) that are return consumer(s) to server 202, and server 202 may associate the value with the hotspot provider at which network device 204 is located and store the value in data store 210.

In accordance with another embodiment, the percentage of consumer(s) that are return consumer(s) of hotspot provider(s) may be determined by server 202. For example, with reference to FIG. 2, server 202 may match consumer device identifiers received via request 254 to previously-received consumer device identifiers to determine if a consumer is a repeat consumer. Server 202 may determine the percentage of consumer(s) that are return consumer(s) based on this matching process and the value of its counter as described above. Server 202 may associate a value corresponding to the percentage of consumer(s) that are return consumer(s) with the particular hotspot and store the value in data store 210.

The demographic makeup of consumer(s) of a particular hotspot provider may be determined based on the demographic information collected by server 102 in a manner as described above with reference to FIGS. 11-13. The collection of contact information for consumer(s) of a particular hotspot may be based on contact information collected via a landing page provided by server 102.

In accordance with an embodiment, the performance indicator(s) may also include behavioral information associated with consumer(s). For example, because server 102 and data store 110 maintain data associated with a plurality of hotspot provider(s), server 102 may be configured to cross-correlate information between hotspot provider(s) to determine various behavioral information associated with a particular consumer. For example, system 102 may be configured to analyze the various hotspot providers that a particular consumer visits and determine patterns in behavior. A hotspot provider may use this information to market themselves accordingly (e.g., by providing advertisements based on where the consumer has been and where the consumer is predicted to go next).

In accordance with another embodiment, the performance indicator(s) may also include an average value of various performance indicator(s) in the hotspot provider's industry. For example, because server 102 and data store 110 maintain data associated with a plurality of hotspot provider(s), server 102 may be enabled to obtain average(s) for various performance indicators on an industry-by-industry basis. A hotspot provider may use these average(s) to determine how well it is performing with respect to other hotspot providers in its industry.

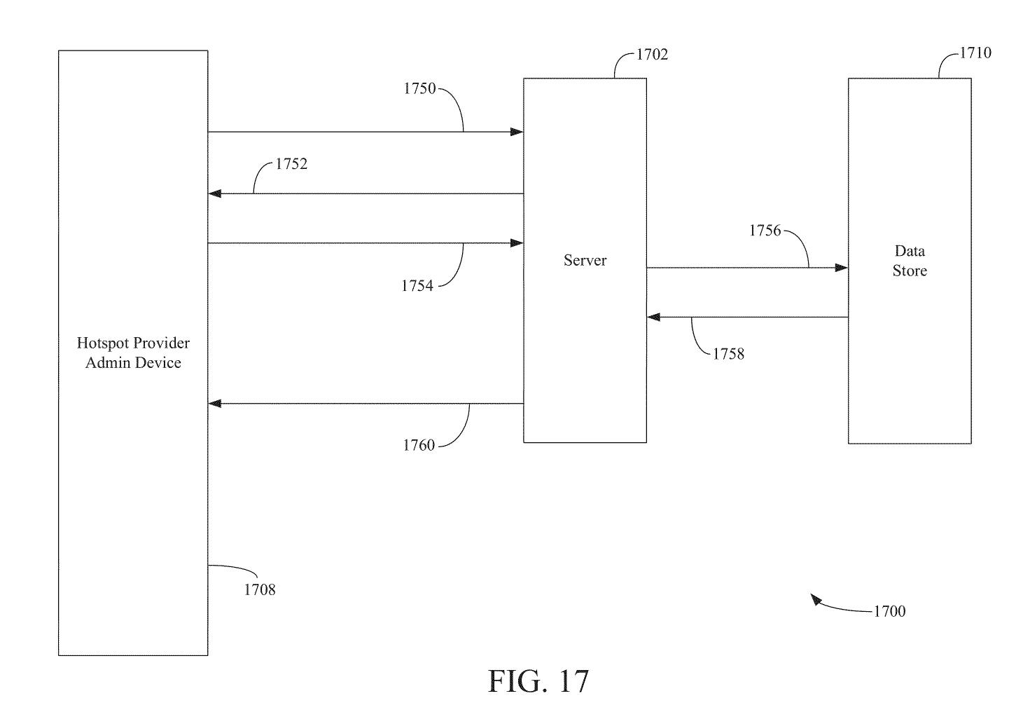

A hotspot provider administrator may be enabled to view the determined performance indicator(s) associated with consumer(s) of the hotspot provider. Accordingly, FIG. 17 shows a block diagram illustrating the operations performed by a system 1700 that enables a hotspot provider administrator to obtain and view performance indicator(s), according to an example embodiment. As shown in FIG. 17, system 1700 includes a server 1702, a hotspot provider admin device 1708, and a data store 1710. Server 1702 is an example of server 102, hotspot provider admin device 1708 is an example of hotspot provider admin device 108, and data store 1710 is an example of data store 110.

As shown in FIG. 17, hotspot provider admin device 1708 may be configured provide a request 1750 for a Web page that provides performance indicator(s) associated with consumer(s) of the hotspot provider. In response, server 1702 may provide an authentication request 1752 to hotspot provider admin device 1708. In accordance with an embodiment, authentication request 1752 may comprise a request for the hotspot provider administrator to log into server 1702, for example, by prompting the user to enter his username and password. Upon the hotspot provider administrator submitting his username and password, hotspot provider admin device 1708 may provide an authentication response 1754 that includes the username and password to server 1702. If authentication response 1754 is valid (e.g., the username and password are valid), server 1702 may be configured to send a query 1756 that requests performance indicator(s) from data store 1710. If authentication response 1754 is invalid, the access to the performance indicator(s) is denied.

In response to receiving query 1756, data store 1710 may return a response 1758 that includes the requested performance indicator(s). In response to receiving response 1758, server 1702 may be configured to generate and provide a Web page (e.g., Web page 1760) that includes the performance indicator(s) to hotspot provider admin device 1708.

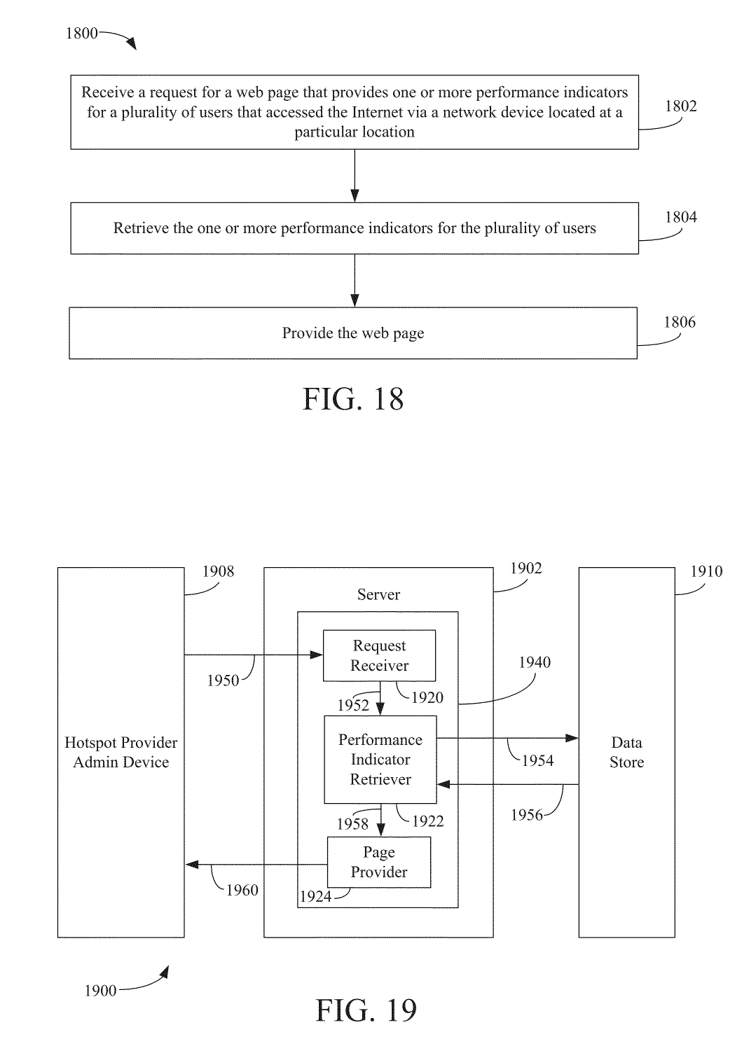

In embodiments, system 1700 may operate in various ways to enable a hotspot provider administrator to obtain and view performance indicator(s) associated with consumer(s) of the hotspot provider. For instance, FIG. 18 shows a flowchart 1800 for enabling a hotspot provider administrator to view performance indicator(s) associated with consumer(s) of the hotspot provider, according to an example embodiment. In an embodiment, system 1700 may operate according to flowchart 1800. Furthermore, FIG. 19 shows a block diagram of system 1900, according to an example embodiment. System 1900 is an example of system 100 or 1700. As shown in FIG. 19, system 1900 includes a server 1902, a hotspot provider admin device 1908, and data store 1910. Server 1902 includes a performance indicator page engine 1940. Performance indicator page engine 1940 includes a request receiver 1920, a performance indicator retriever 1922, and a page provider 1924. Server 1902, hotspot provider admin device 1908, and data store 1910 are examples of server 102 or 1702, hotspot provider admin device 108 or 1708, and data store 110 or data store 1710, as respectively shown in FIGS. 1 and 17. Performance indicator page engine 1940 is an example of performance indicator page engine 140, as shown in FIG. 1. Flowchart 1800 is described with respect to system 1900 for illustrative purposes. Further structural and operational embodiments will be apparent to persons skilled in the relevant art(s) based on the following description of flowchart 1800 and system 1900.

Flowchart 1800 begins with step 1802. In step 1802, a request for a Web page that provides one or more performance indicators for a plurality of users that accessed the Internet via a network device located at a particular location is received. For example, in an embodiment, request receiver 1920 receives a request 1950 for a Web page that provides performance indicator(s) for consumer(s) that accessed the Internet via a network device (not shown) located at a hotspot provider.

In step 1804, the performance indicator(s) for the plurality of users are retrieved. For example, in an embodiment, rating receiver 1622 provides a notification 1952 to performance indicator retriever 1922 in response to receiving request 1950. Notification 1952 may cause performance indicator retriever 1922 to send a query 1954 for performance indicator(s) stored in data store 1910. In response, data store 1910 may provide a response 1956 that includes the performance indicator(s).

In step 1806, the web page is provided. For example, in an embodiment, performance indicator retriever 1922 provides performance indicator(s) 1958 to page provider 1924. Page provider 1924 may be configured to generate and provide a Web page 1960 that includes performance indicator(s) 1958 to hotspot provider admin device 1908.

### III. Server Administrator Interface

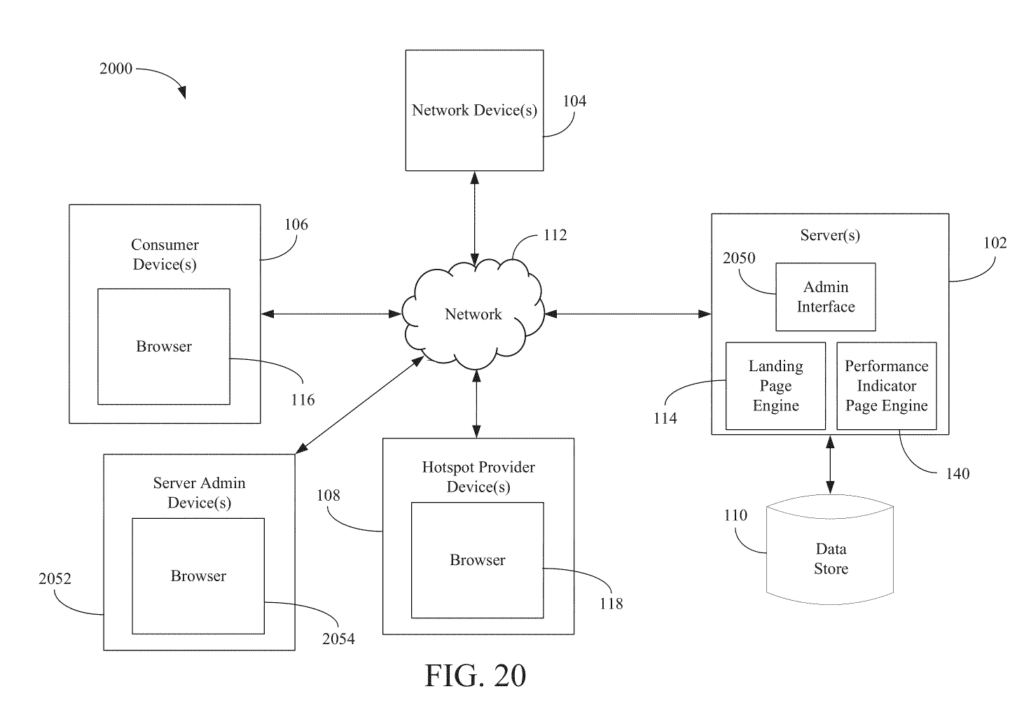

Referring again to FIG. 1, in embodiments, an administrator of server 102 (i.e. a server administrator) may be enabled to view and configure information associated with each of the hotspot providers maintained by system 100. Such an embodiment is shown in FIG. 20. FIG. 20 is a block diagram of a communication system 2000 in which server administrator(s) are enabled to view and configure information associated with each of the hotspot providers maintained by system 2000, according to an example embodiment. As shown in FIG. 20, server 102 further includes an admin interface 2050. Admin interface 2050 may be configured to provide a graphical user interface (GUI) that enables a server administrator to view and configure information associated with each of the hotspot providers maintained by system 2000.

A server administrator may access admin interface 2050 using one or more server admin device(s) 2052. Server admin device(s) 2052 may be any type of stationary or mobile computing device, including a desktop computer (e.g., a personal computer, etc.), a mobile computer or computing device (e.g., a Palm® device, a RIM Blackberry® device, a personal digital assistant (PDA), a laptop computer, a notebook computer, a tablet computer (e.g., an Apple iPad™), a smart phone (e.g., an Apple iPhone, a Google Android™ phone, a Microsoft Windows® phone, etc.), or other type of computing device.

Server admin device(s) 2052 may include a client that enables a server administrator to view and interact with the GUI provided by admin interface 2050. For instance, a client may be a Web browser or any other suitable type of client. As shown in FIG. 20, server admin device(s) 2052 includes a browser 2054.

Browser 2054 may be a software application that is configured to retrieve, present, and traverse network-accessible content, such as Web sites or GUIs provided by server 102 or other server(s). Some well-known Web browsers include Internet Explorer® (published by Microsoft Corporation of Redmond, Wash.), Firefox® (published by Mozilla Corporation of Mountain View, Calif.), and Chrome™ (published by Google Inc. of Mountain View, Calif.).

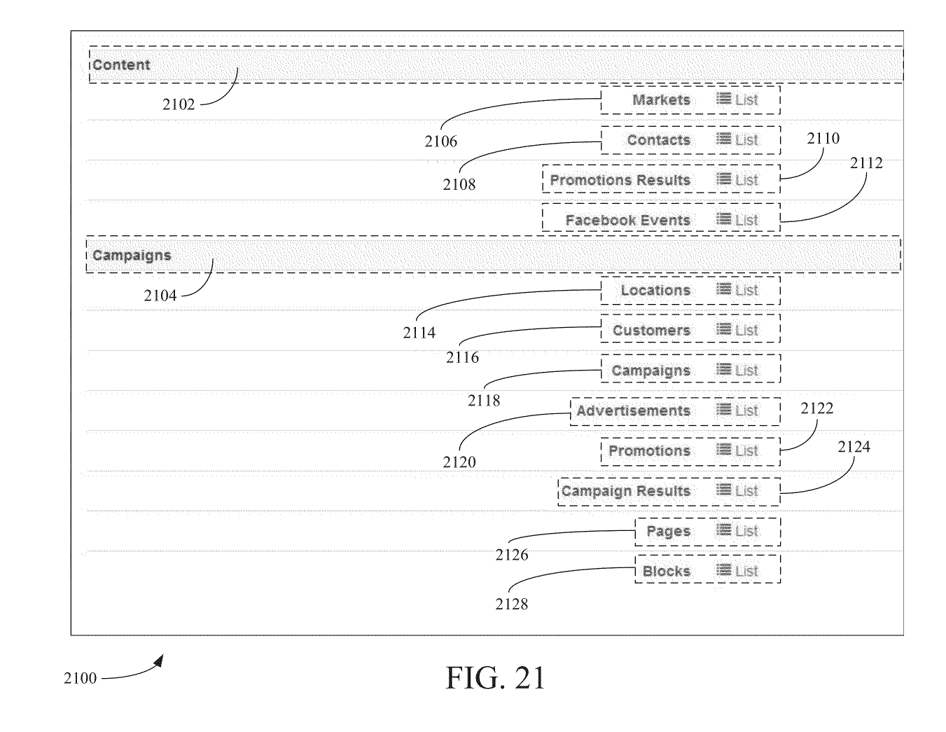

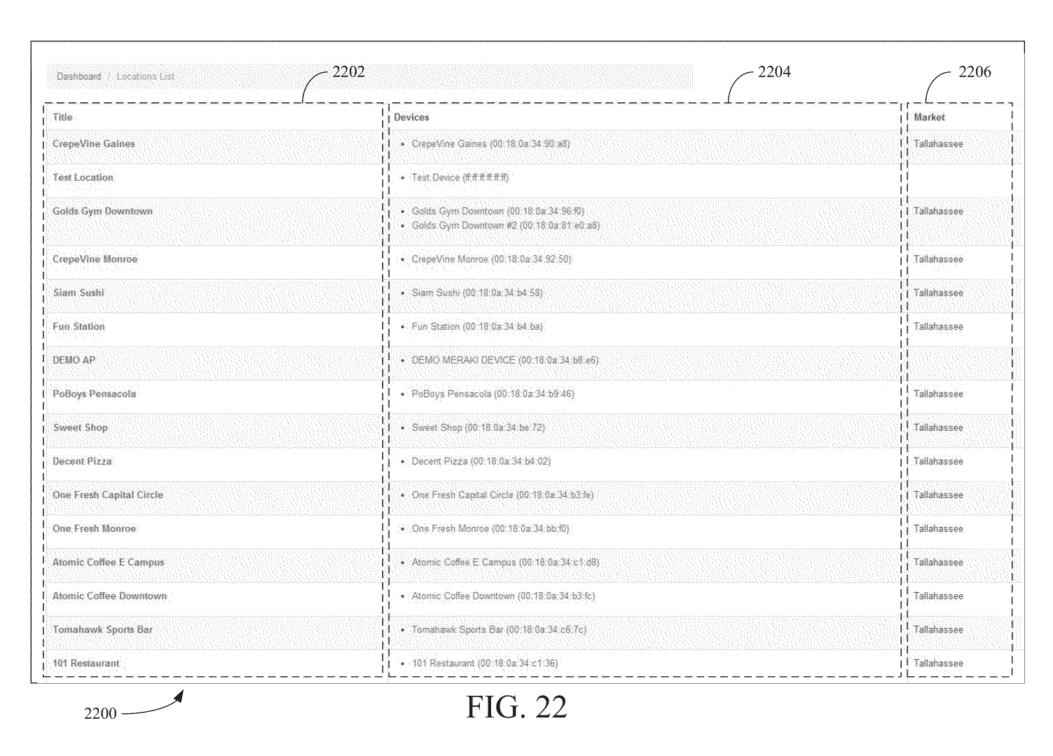

FIGS. 21-27 depict various GUI screens provided by admin interface 2050. For example, FIG. 21 depicts a main GUI screen 2100 that enables a server administrator to view various pieces of information associated with each of the hotspot providers maintained by system 2000, according to an example embodiment. As shown in FIG. 21, main GUI screen 2100 includes a content section 2102 and a campaigns section 2104. Content section 2102 includes interface elements 2106, 2108, 2110, and 2112. Interface element 2106, when activated, causes admin interface 2050 to provide a GUI screen that displays each of the markets (e.g., geographical locations) in which hotspot provider(s) are maintained by system 2000. Interface element 2108, when activated, causes admin interface 2050 to provide a GUI screen that displays contact information for hotspot provider administrator(s) associated with each hotspot provider maintained by system 2000. Interface element 2110, when activated, causes admin interface 2050 to provide a GUI screen that displays a list of promotions (e.g., incentives) that have been offered to consumer(s) and a list of promotions that have not been offered to consumer(s). Interface element 2112, when activated, causes admin interface 2050 to provide a GUI screen that displays social networking events that may be provided to consumer(s).

Campaigns section 2104 may include interface element 2114, interface element 2116, interface element 2118, interface element 2120, interface element 2122, interface element 2124, interface element 2216, and interface element 2128. Interface element 2114, when activated, may cause admin interface 2050 to provide a GUI screen that displays a list of hotspot providers, network devices located at those hotspot providers, and the markets in which those hotspot providers are located. For example, FIG. 22 depicts a GUI screen 2200 that displays such a list, according to an example embodiment. As shown in FIG. 22, GUI screen 2200 includes at least a title section 2202, a devices section 2204, and a market section 2206. Title section 2202 lists the names of each of the hotspot providers maintained by system 2000. Devices section 2204 lists the names for each of the network devices (e.g., network device(s) 104) associated with each of the hotspot providers. Market section 2206 lists the markets for each of the hotspot providers.

Each of the hotspot provider names may be interface elements, which, when activated, cause admin interface 2050 to provide a GUI screen that provides additional information about the corresponding hotspot provider. Such information may include the advertisement campaigns associated with the corresponding hotspot provider and various advertisement metrics associated with that campaign (e.g., views, clicks and/or click-through rates (CTRs).

Interface element 2116, when activated, may cause admin interface 2050 to provide a GUI screen that displays a list of hotspot providers, the markets in which those hotspot providers are located, and contact information for those hotspot providers.

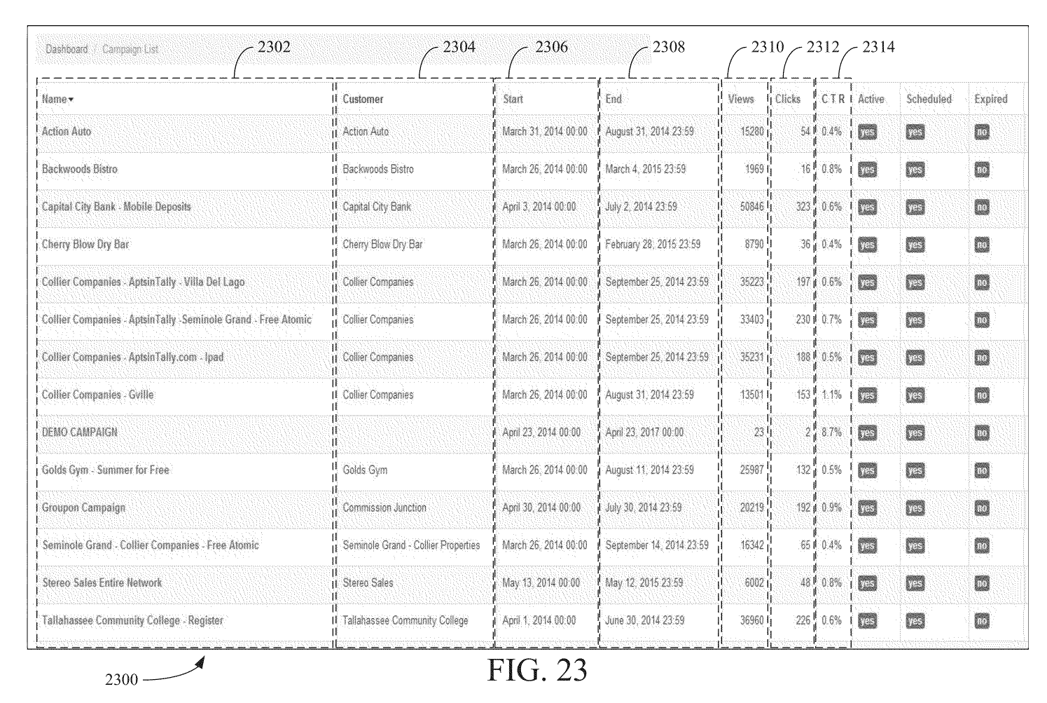

Interface element 2118, when activated, may cause admin interface 2050 to provide a GUI screen that displays a list of advertisement campaigns and various information associated with those advertisement campaigns. For example, FIG. 23 depicts a GUI screen 2300 that displays such a list, according to an example embodiment. As shown in FIG. 23, GUI screen 2300 includes at least a name section 2302, a customer section 2304, a start section 2306, an end section 2308, a views section 2310, a clicks section 2312, and a CTR section 2314. Name section 2302 lists the names of each of the advertisement campaigns maintained by system 2000. Customer section 2304 lists the hotspot provider names associated with each of the advertisement campaigns. Start section 2306 lists the start date and/or start time for each of the advertisement campaigns. End section 2308 lists the end date and/or end time for each of the advertisement campaigns. Views section 2310 lists the number of views for each of the advertisement campaigns. Clicks section 2312 lists the number of clicks received for each of the advertisement campaigns. CTR section 2314 lists the CTRs (i.e., the number of clicks divided by the number of views) for each of the advertisement campaigns.

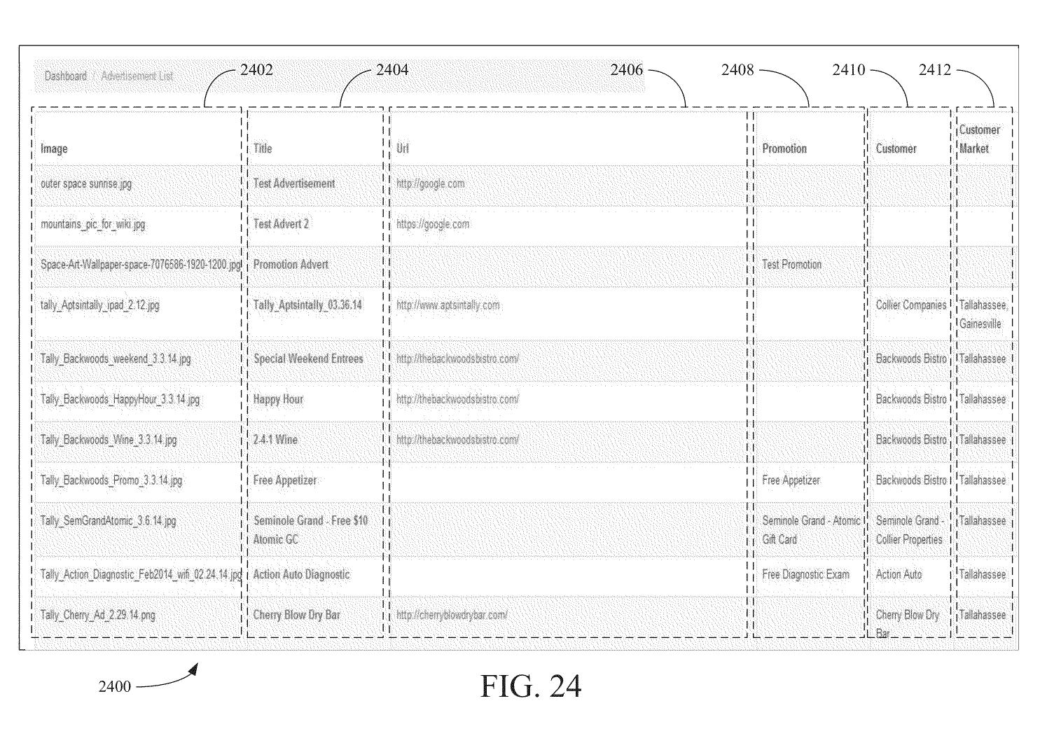

Interface element 2120, when activated, may cause admin interface 2050 to provide a GUI screen that displays a list of advertisements and various information associated with those advertisements. For example, FIG. 24 depicts a GUI screen 2400 that displays such a list, according to an example embodiment. As shown in FIG. 24, GUI screen 2400 includes at least an image section 2402, a title section 2404, a URL section 2406, a promotion section 2408, a customer section 2410, and a customer market section 2412. Image section 2402 lists the names for the images that are displayed for the advertisements. Title section 2404 lists the names for each of the advertisements. URL section 2406 lists the URLs for the hotspot providers associated with each of the advertisements. Promotion section 2408 lists incentives that are associated with the advertisements. Customer section 2410 lists the names of the hotspot providers associated with the advertisements. Customer market section 2412 lists the markets for each of the hotspot providers associated with the advertisements.

Interface element 2122, when activated, may cause admin interface 2050 to provide a GUI screen that displays a list of incentives and various information associated with those advertisements. Examples of such information include, but are not limited to, a list of the names of the images that are displayed for the incentives, a list of the names of businesses that each incentive is for, a list of titles for each of the incentives, etc.

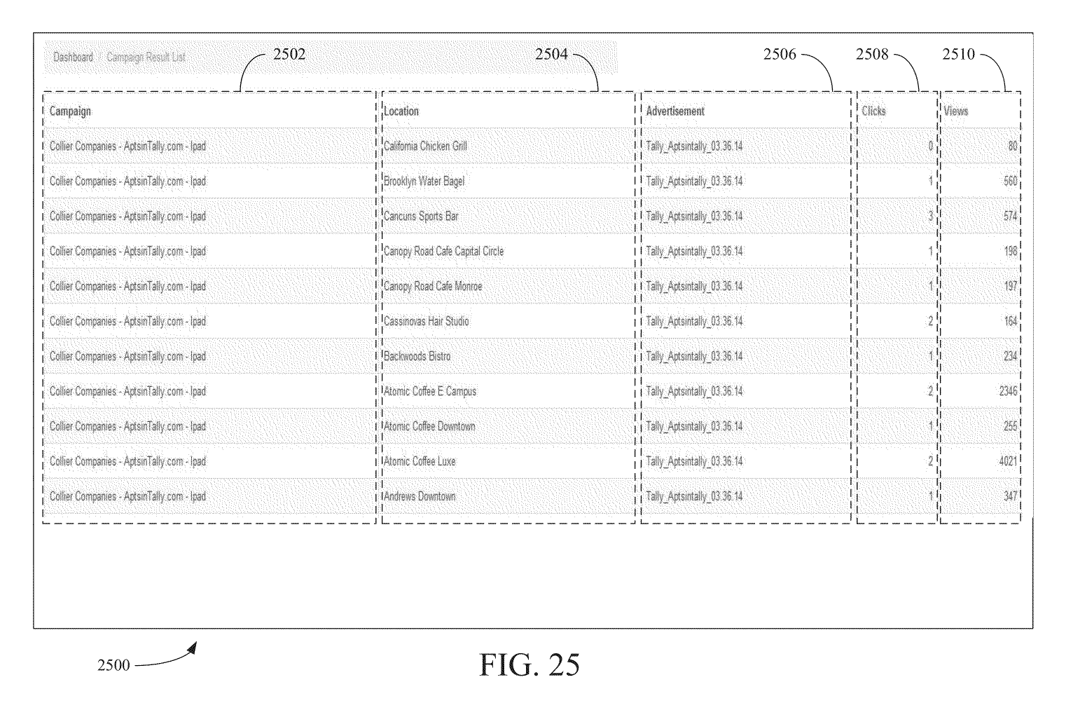

Interface element 2124, when activated, may cause admin interface 2050 to provide a GUI screen that displays a list of results for each of the advertisement campaigns. For example, FIG. 25 depicts a GUI screen 2500 that displays such a list, according to an example embodiment. As shown in FIG. 25, GUI screen 2500 includes at least a campaign section 2502, a location section 2504, an advertisement section 2506, a clicks section 3508, and a views section 2510. Campaign section 2502 lists the names of the advertisement campaigns maintained by system 2000. Location section 2504 lists the names of the hotspot providers associated with each of the campaigns. Advertisement section 2506 lists the names of the advertisements associated with each of the campaigns. Clicks section 2508 lists the number of clicks for each of the advertisements associated with each of the advertisement campaigns. Views section 2508 lists the number of views for each of the advertisements associated with each of the advertisement campaigns.

Interface element 2126, when activated, may cause admin interface 2050 to provide a GUI screen that displays a list of landing pages associated with each of the hotspot providers maintained by system 2000. The GUI screen may also include additional information associated with each of the landing pages. Examples of such information include, but are not limited to, indication(s) as to whether each landing page is active or inactive, an expiration date for each of the landing pages, etc.

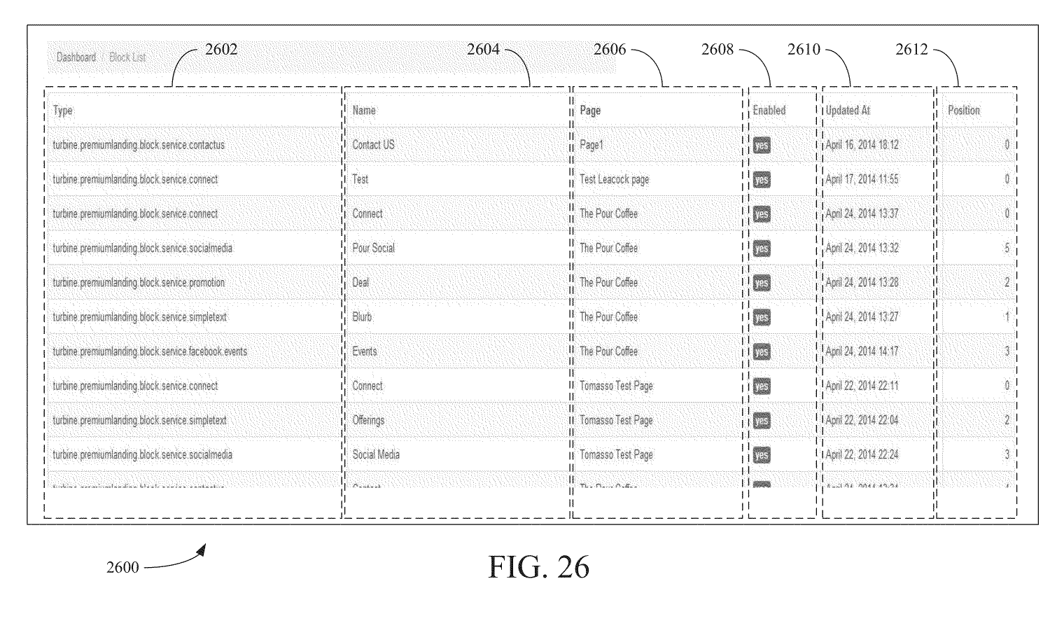

Interface element 2128, when activated, may cause admin interface 2050 to provide a GUI screen that displays a list of details regarding each block (i.e., section) for each of the landing pages maintained by system 2000. For example, FIG. 26 depicts a GUI screen 2600 that displays such a list, according to an example embodiment. As shown in FIG. 26, GUI screen 2600 includes at least a type section 2602, a name section 2604, a page section 2606, an enabled section 2608, an update section 2610, and a position section 2612. Type section 2502 lists the type of block for a particular landing page. The types may include, but are not limited to, a “Contact Us” section, which enables a consumer to contact the hotspot provider (e.g., via e-mail or telephone), a “Connect” section, which enables a consumer to connect to the Internet via the hotspot, a simple text section, which displays various textual information associated with the hotspot provider, a demographic section, which enables a consumer to enter in demographic information associated with the consumer, a social media section, which enables a consumer to interact with a “liking” service, a promotion section, which enables a consumer to interact with an incentive service, a survey section, which enables a consumer to interact with a survey service, a rating section, which enables a consumer to interact with a rating service, etc.

Name section 2604 lists the names for each of the blocks. Page section 2606 lists the names of the landing pages associated with each of the blocks. Enabled section 2608 provides an indication as to whether each of the blocks are enabled or disabled. Updated section 2610 provides a date and/or time for each block. The date and/or time represents the last date and/or time that a particular block was updated. Position section 2612 provides a position value for each block. The position value represents the position of a particular block on a particular landing page. For example, in accordance with an embodiment, a low position value may correspond to a position near the top of the landing page, and a high position value may correspond to a position near the bottom of the landing page, or vice versa.

### IV. Example Computer System Implementations

Any of the components of system 100, as described above in reference to FIG. 1, any of the components of system 200, as described above in reference to FIG. 2, any of the components of system 300, as described above in reference to FIG. 3, any of the components of system 500, as described above in reference to FIG. 5, any of the components of system 700, as described above in reference to FIG. 7, any of the components of system 800, as described above in reference to FIG. 8, any of the components of system 1000, as described above in reference to FIG. 10, any of the components of system 1100, as described above in reference to FIG. 11, any of the components of system 1300, as described above in reference to FIG. 13, any of the components of system 1400, as described above in reference to FIG. 14, any of the components of system 1600, as described above in reference to FIG. 16, any of the components of system 1700, as described above in reference to FIG. 17, any of the components of system 1900, as described above in reference to FIG. 19, any of the components of system 2000, as described above in reference to FIG. 20, any of the GUI screens (or portions thereof) shown in FIGS. 21-27, any of all of the steps of flowchart 400 depicted in FIG. 4, any of all of the steps of flowchart 600 depicted in FIG. 6, any of all of the steps of flowchart 900 depicted in FIG. 9, any of all of the steps of flowchart 1200 depicted in FIG. 12, any of all of the steps of flowchart 1500 depicted in FIG. 15, any of all of the steps of flowchart 1800 depicted in FIG. 18, and/or any further systems, sub-systems, and/or components disclosed herein may be implemented in hardware, or any combination of hardware with software and/or firmware. For example, any of the components of system 100, any of the components of system 200, any of the components of system 300, any of the components of system 500, any of the components of system 700, any of the components of system 800, any of the components of system 1000, any of the components of system 1100, any of the components of system 1300, any of the components of system 1400, any of the components of system 1600, any of the components of system 1700, any of the components of system 1900, any of the components of system 2000, any of the GUI screens (or portions thereof) shown in FIGS. 21-27, any of all of the steps of flowchart 400, any of all of the steps of flowchart 600, any of all of the steps of flowchart 900, any of all of the steps of flowchart 1200, any of all of the steps of flowchart 1500, and/or any of all of the steps of flowchart 1800 may be implemented as computer program code configured to be executed in one or more processors. Alternatively, any of the components of system 100, any of the components of system 200, any of the components of system 300, any of the components of system 500, any of the components of system 700, any of the components of system 800, any of the components of system 1000, any of the components of system 1100, any of the components of system 1300, any of the components of system 1400, any of the components of system 1600, any of the components of system 1700, any of the components of system 1900, any of the components of system 2000, any of the GUI screens (or portions thereof) shown in FIGS. 21-27, any of all of the steps of flowchart 400, any of all of the steps of flowchart 600, any of all of the steps of flowchart 900, any of all of the steps of flowchart 1200, any of all of the steps of flowchart 1500, and/or any of all of the steps of flowchart 1800 may be implemented as hardware logic/electrical circuitry.

As described above, landing page engines, performance indicator page engines, admin interfaces, and/or browsers may generate one or more user interfaces. For instance, landing page engines, performance indicator page engines, admin interfaces, and/or browsers may enable user input to be provided from one or more of any types of user interface elements provided by a computing device, including a keyboard, a thumb wheel, a pointing device, a roller ball, a stick pointer, a touch sensitive display, any number of virtual interface elements, a voice recognition system, etc. GUIs may be displayed in a display of the computing device, such as in a browser window generated by a web browser, an application window, or in other window type mentioned elsewhere herein or otherwise known.

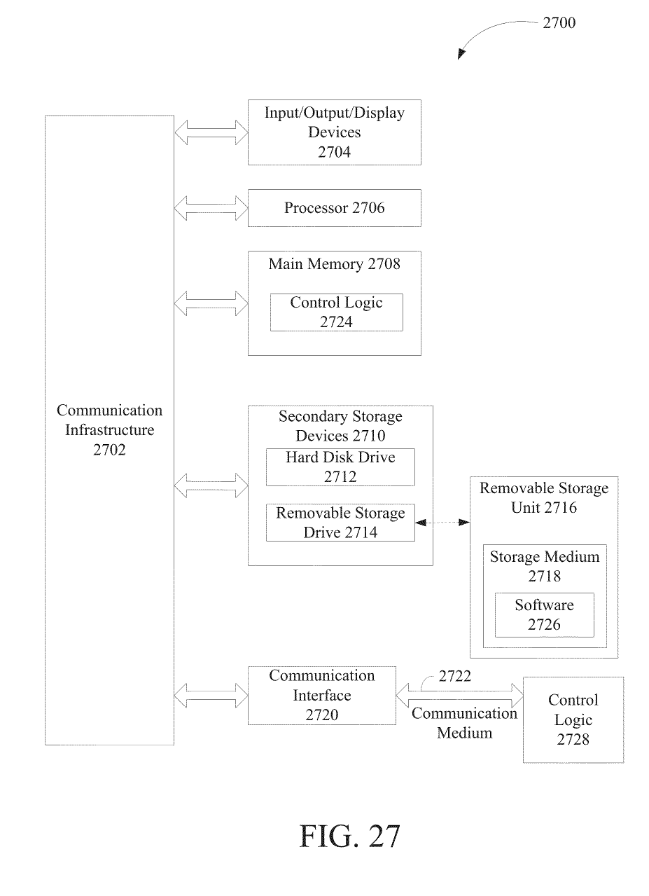

The embodiments described herein, including systems, methods/processes, and/or apparatuses, may be implemented using well known servers/computers, such as a computer 2700 shown in FIG. 27. For example, any of the components of system 100, any of the components of system 200, any of the components of system 300, any of the components of system 500, any of the components of system 700, any of the components of system 800, any of the components of system 1000, any of the components of system 1100, any of the components of system 1300, any of the components of system 1400, any of the components of system 1600, any of the components of system 1700, any of the components of system 1900, any of the components of system 2000, any of the GUI screens (or portions thereof) shown in FIGS. 21-27, any of all of the steps of flowchart 400, any of all of the steps of flowchart 600, any of all of the steps of flowchart 900, any of all of the steps of flowchart 1200, any of all of the steps of flowchart 1500, and/or any of all of the steps of flowchart 1800 may be implemented using one or more computers 2700.

Computer 2700 can be any commercially available and well known computer capable of performing the functions described herein, such as computers available from International Business Machines, Apple, Sun, HP, Dell, Cray, etc. Computer 2700 may be any type of computer, including a desktop computer, a server, etc.

Computer 2700 includes one or more processors (also called central processing units, or CPUs), such as a processor 2706. Processor 2706 is connected to a communication infrastructure 2702, such as a communication bus. In some embodiments, processor 2706 can simultaneously operate multiple computing threads.

Computer 2700 also includes a primary or main memory 2708, such as random access memory (RAM). Main memory 2708 has stored therein control logic 2724 (computer software), and data.

Computer 2700 also includes one or more secondary storage devices 2710. Secondary storage devices 2710 include, for example, a hard disk drive 2712 and/or a removable storage device or drive 2714, as well as other types of storage devices, such as memory cards and memory sticks. For instance, computer 2700 may include an industry standard interface, such a universal serial bus (USB) interface for interfacing with devices such as a memory stick. Removable storage drive 2714 represents a floppy disk drive, a magnetic tape drive, a compact disk drive, an optical storage device, tape backup, etc.

Removable storage drive 2714 interacts with a removable storage unit 2716. Removable storage unit 2716 includes a computer useable or readable storage medium 2718 having stored therein computer software 2726 (control logic) and/or data. Removable storage unit 2716 represents a floppy disk, magnetic tape, compact disk, DVD, optical storage disk, or any other computer data storage device. Removable storage drive 2714 reads from and/or writes to removable storage unit 2716 in a well-known manner.

Computer 2700 also includes input/output/display devices 2704, such as monitors, keyboards, pointing devices, etc.

Computer 2700 further includes a communication or network interface 2718. Communication interface 2720 enables computer 2700 to communicate with remote devices. For example, communication interface 2720 allows computer 2700 to communicate over communication networks or mediums 2722 (representing a form of a computer useable or readable medium), such as LANs, WANs, the Internet, etc. Network interface 2720 may interface with remote sites or networks via wired or wireless connections.

Control logic 2728 may be transmitted to and from computer 2700 via the communication medium 2722.

Any apparatus or manufacture comprising a computer useable or readable medium having control logic (software) stored therein is referred to herein as a computer program product or program storage device. This includes, but is not limited to, computer 2700, main memory 2708, secondary storage devices 2710, and removable storage unit 2716. Such computer program products, having control logic stored therein that, when executed by one or more data processing devices, cause such data processing devices to operate as described herein, represent embodiments of the invention.

Devices in which embodiments may be implemented may include storage, such as storage drives, memory devices, and further types of computer-readable media. Examples of such computer-readable storage media include a hard disk, a removable magnetic disk, a removable optical disk, flash memory cards, digital video disks, random access memories (RAMs), read only memories (ROM), and the like. As used herein, the terms “computer program medium” and “computer-readable medium” are used to generally refer to the hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may store program modules that include computer program logic for implementing any of the components of system 100, any of the components of system 200, any of the components of system 300, any of the components of system 500, any of the components of system 700, any of the components of system 800, any of the components of system 1000, any of the components of system 1100, any of the components of system 1300, any of the components of system 1400, any of the components of system 1600, any of the components of system 1700, any of the components of system 1900, any of the components of system 2000, any of the GUI screens (or portions thereof) shown in FIGS. 21-27, any of all of the steps of flowchart 400, any of all of the steps of flowchart 600, any of all of the steps of flowchart 900, any of all of the steps of flowchart 1200, any of all of the steps of flowchart 1500, and/or any of all of the steps of flowchart 1800, and/or further embodiments described herein. Embodiments of the invention are directed to computer program products comprising such logic (e.g., in the form of program code, instructions, or software) stored on any computer useable medium. Such program code, when executed in one or more processors, causes a device to operate as described herein.

Note that such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media. Embodiments are also directed to such communication media.

### V. Conclusion

While various embodiments of the present invention have been described above, it should be understood that they have been presented by way of example only, and not limitation. It will be apparent to persons skilled in the relevant art(s) that various changes in form and details may be made to the embodiments described above without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for providing Internet access at a location, comprising:
receiving a request for a landing page, wherein the request includes one or more parameters;
providing one of a first landing page or a second landing page based on the one or more parameters to a user device of a user, wherein the second landing page enables the user to interact with one or more services that are associated with the location, and wherein the first landing page does not enable the user to interact with the one or more services; and
upon providing the second landing page:
determining whether the user has interacted with the one or more services; and
providing access to the Internet in response to determining that the user has interacted with the one or more services.

2. The method of claim 1, wherein providing access to the Internet in response to determining that the user has interacted with the one or more services comprises:
providing one or more advertisements to the user device in response to determining that the user has interacted with the one or more services, wherein the one or more advertisements are displayed by the user device for a predetermined time period; and
enabling the user via the user device to connect to the Internet via an interface element upon expiration of the predetermined time period, wherein access to the Internet is provided upon the user activating the interface element via the user device.

3. The method of claim 2, further comprising:
receiving a first notification that the one or more advertisements have been displayed to the user;
receiving a second notification that the user has selected at least one advertisement of the one or more advertisements;
storing the first notification and the second notification; and
providing a resource identifier associated with the at least one advertisement to the user device in response to receiving the second notification.

4. The method of claim 1, further comprising:
providing a demographic information page that includes one or more interface elements that enable the user to enter in demographic information associated with the user to the user device; and
receiving and storing the demographic information in a database.

5. The method of claim 4, wherein the demographic information includes at least one of:
the age of the user;
the gender of the user; and
the location of the user.

6. The method of claim 1, wherein the one or more parameters comprise at least one of:
an internet protocol address of the user device;
a media access control address of the user device; and
an identification of a network device to which the user device is connected, wherein the network device is located at the location.

7. The method of claim 6, wherein said providing one of a first landing page or a second landing page based on the one or more parameters to a user device of the user comprises:
determining whether the network device is designated for receiving the first landing page or the second landing page;
providing the first landing page in response to determining that the identification of the network device is designated for receiving the first landing page; and
providing the second landing page in response to determining that the identification of the network device is designated for receiving the second landing page.

8. The method of claim 1, wherein the one or more services comprise at least one of:
a rating service that enables the user to rate the location;
a “liking” service that enables the user to “like” the location via a social network.
a survey service that enables the user to take a survey associated with the location; or
an incentive service that enables the user to share an incentive associated with the location or register for the incentive.

9. The method of claim 8, further comprising:
receiving a notification that includes a rating provided by the user;
determining whether the notification includes a positive rating or a negative rating;
in response to determining that the notification includes a positive rating, providing the positive rating to the rating service via an application programming interface; and
in response to determining that the notification includes a negative rating, enabling the user to provide additional information regarding the negative rating and providing the negative rating and the additional information to the rating service via the application programming interface.

10. A system for providing Internet access at a location, comprising:
a request receiver configured to receive a request for a landing page, wherein the request includes one or more parameters;
a landing page provider configured to provide one of a first landing page or a second landing page based on the one or more parameters to a user device of a user, wherein the second landing page enables the user to interact with one or more services that are associated with the location, and wherein the first landing page does not enable the user to interact with the one or more services;
an interaction detector configured to determine whether the user has interacted with the one or more services upon provision of the second landing page; and
an access grantor configured to provide access to the Internet in response to a determination that the user has interacted with the one or more services.

11. The system of claim 10, further comprising:
an advertisement provider configured to provide one or more advertisements to the user device in response to determining that the user has interacted with the one or more services, wherein the one or more advertisements are displayed by the user device for a predetermined time period;
wherein the access grantor is further configured to enable the user via the user device to connect to the Internet via an interface element upon expiration of the predetermined time period, wherein access to the Internet is provided upon the user activating the interface element via the user device.

12. The system of claim 11, further comprising:
an activity detector configured to receive a first notification that the one or more advertisements have been displayed to the user, wherein the activity detector is further configured to receive a second notification that the user has selected at least one advertisement of the one or more advertisements, and wherein the activity detector is further configured to store the first notification and the second notification in a database; and
an advertiser page provider configured to provide a resource identifier associated with the at least one advertisement to the user device in response to receiving the second notification.

13. The system of claim 10, further comprising:
a demographic information page provider configured to provide a demographic information page that includes one or more interface elements that enable the user to enter in demographic information associated with the user to the user device; and
an interaction detector configured to receive and store the demographic information in a database.

14. The system of claim 13, wherein the demographic information includes at least one of:
the age of the user;
the gender of the user; and
the location of the user.

15. The system of claim 10, wherein the one or more parameters comprise at least one of:
an internet protocol address of the user device;
a media access control address of the user device; and
an identification of a network device to which the user device is connected, wherein the network device is located at the location.

16. The system of claim 10, wherein the one or more services comprise at least one of:
a rating service that enables the user to rate the location;
a “liking” service that enables the user to “like” the location via a social network.
a survey service that enables the user to take a survey associated with the location; or
an incentive service that enables the user to share an incentive associated with the location or register for the incentive.

17. The system of claim 16, further comprising:
a rating receiver configured to:
receive a notification that includes a rating provided by the user,
determine whether the notification includes a positive rating or a negative rating;
provide the positive rating to the rating service via an application programming interface in response to a determination by the rating receiver that the notification includes the positive rating; and
provide the negative rating to the rating service via the application programming interface in response to a determination by the rating receiver that the notification includes the negative rating; and
a feedback requestor configured to, in response to a determination by the rating receiver that the notification includes the negative rating, enable a user to provide additional regarding the negative rating.

18. A method, comprising:
receiving a request for a web page that provides one or more performance indicators for a plurality of users that accessed the Internet via a network device located at a particular location;
retrieving the one or more performance indicators for the plurality of users;
providing the web page.

19. The method of claim 18, wherein providing the web page comprises:
providing an authentication request to a user device that requested the web page;
receiving an authentication response from the user;
determining whether the authentication response is valid; and
providing the web page in response to determining that the authentication response is valid.

20. The method of claim 18, wherein the one or more performance indicators comprise:
a number of the plurality of users that visit the location;
a number of the plurality of users that have been provided access to the Internet at the location;
a dwell time of each of the plurality of users at the location;
a percentage of the plurality of users that are return users to the location; and
demographic information associated with the plurality of users.
